(19) United States
(12) Patent Application Publication
(10) Pub. No.: US 2026/0037789 A1
(43) Pub. Date: Feb. 5, 2026

(54) TENSOR TRANSFORMATION

(71) Applicant: INTERNATIONAL BUSINESS MACHINES CORPORATION, Armonk, NY (US)

(72) Inventors: Cedric Lichtenau, Stuttgart (DE); Dan Greiner, San Jose, CA (US); Timothy J Slegel, Staatsburg, NY (US); Preetham M. Lobo, Bangalore (IN)

(21) Appl. No.: 18/792,876

(22) Filed: Aug. 2, 2024

(51) Int. Cl. G06N 3/063

(52) U.S. Cl. CPC G06N 3/063

(57) ABSTRACT

Tensor transformation includes obtaining an input tensor having a first data-layout format and elements of a first data type, and reformatting the input tensor to provide an output tensor having a second data-layout format and elements of a second data type, where the second data-layout is different from the first data-layout format and the second data type is different from the first data type. Optionally, the reformatting includes element quantization on input elements of the input tensor, where the element quantization performed on an input element of the input tensor includes converting the input element to an output element, of the second data type, as an element of the output tensor, using the scale value to scale to the input element, the offset value to apply an offset, and the clip maximum and clip minimum values to enforce a maximum value and a minimum value for the output element.

### BACKGROUND

One or more aspects relate, in general, to facilitating processing within a computing environment, and in particular, to improving such processing.

In order to enhance processing in computing environments that are data and/or computational-intensive, co-processors are utilized, such as artificial intelligence accelerators (also referred to as neural network processors or neural network accelerators). Such accelerators provide a great deal of compute power used in performing, for instance, involved computations, such as computations on matrices or tensors.

Tensor computations, as an example, are used in complex processing, including deep learning, which is a subset of machine learning. Deep learning or machine learning, an aspect of artificial intelligence, is used in various technologies, including but not limited to, engineering, manufacturing, medical technologies, automotive technologies, computer processing, etc.

To perform artificial intelligence workloads, including tensor computations, a software implementation may be used that executes many instructions on a general-purpose processor or uses a purpose-built hardware implementation. Using many instructions on a general-purpose processor can limit the performance of neural network operations. Further, in programming a purpose-built hardware implementation, the program may have to be modified and recompiled for each hardware generation, increasing complexity and verification costs.

### SUMMARY

Shortcomings of the prior art are overcome, and additional advantages are provided through the provision of a computer program product. The computer program product includes a set of one or more computer-readable storage media and program instructions, collectively stored in the set of one or more computer-readable storage media, for causing at least one computing device to perform computer operations. The computer operations include executing an instruction. Executing the instruction includes obtaining an input tensor having a first data-layout format and elements of a first data type. Executing the instruction further includes reformatting the input tensor to provide an output tensor having a second data-layout format, the second data-layout being different from the first data-layout format, and elements of a second data type, the second data type being different from the first data type.

In one or more aspects, a computer system is provided. The computer system includes at least one computing device. The computer system additionally includes a set of one or more computer-readable storage media. The computer system also includes program instructions, collectively stored in the set of one or more computer-readable storage media, for causing the at least one computing device to perform computer operations. The computer operations include executing an instruction. Executing the instruction includes obtaining an input tensor having a first data-layout format and elements of a first data type. Executing the instruction further includes reformatting the input tensor to provide an output tensor having a second data-layout format, the second data-layout being different from the first data-layout format, and elements of a second data type, the second data type being different from the first data type.

In one or more aspects, a computer-implemented method is provided. The method includes executing an instruction. Executing the instruction includes obtaining an input tensor having a first data-layout format and elements of a first data type. Executing the instruction further includes reformatting the input tensor to provide an output tensor having a second data-layout format, the second data-layout being different from the first data-layout format, and elements of a second data type, the second data type being different from the first data type.

In one or more aspects, a computer system is provided. The computer system includes at least one hardware accelerator to be used in executing an instruction. Executing the instruction includes obtaining an input tensor having a first data-layout format and elements of a first data type. Executing the instruction also includes obtaining from a parameter block specified by the instruction a transformation indicator. The transformation indicator indicates a second data-layout format and a second data type to use in reformatting the input tensor. Also obtained from the parameter block specified by the instruction is a scale value. Additionally obtained from the parameter block specified by the instruction is an offset value. Further obtained from the parameter block specified by the instruction are a clip maximum value and a clip minimum value for enforcing output values within a specified range. Executing the instruction further includes reformatting the input tensor to provide an output tensor having the second data-layout format, the second data-layout being different from the first data-layout format, and elements of a second data type, the second data type being different from the first data type. The reformatting is performed based on the transformation indicator. The reformatting includes performing element quantization on input elements of the input tensor. The element quantization performed on an input element of the input tensor includes converting the input element to an output element, of the second data type, as an element of the output tensor. The converting uses the scale value to scale to the input element. The converting also uses the offset value to apply an offset. The converting further uses the clip maximum and clip minimum values to enforce a maximum value and a minimum value for the output element.

In one or more aspects, a computer-implemented method is provided. The method includes executing an instruction. Executing the instruction includes obtaining an input tensor having a first data-layout format and elements of a first data type. Executing the instruction also includes obtaining from a parameter block specified by the instruction a transformation indicator. The transformation indicator indicates a second data-layout format and a second data type to use in reformatting the input tensor. Also obtained from the parameter block specified by the instruction is a scale value. Additionally obtained from the parameter block specified by the instruction is an offset value. Further obtained from the parameter block specified by the instruction are a clip maximum value and a clip minimum value for enforcing output values within a specified range. Executing the instruction further includes reformatting the input tensor to provide an output tensor having the second data-layout format, the second data-layout being different from the first data-layout format, and elements of a second data type, the second data type being different from the first data type. The reformatting is performed based on the transformation indicator. The reformatting includes performing element quantization on input elements of the input tensor. The element quantization performed on an input element of the input tensor includes converting the input element to an output element, of the second data type, as an element of the output tensor. The converting uses the scale value to scale to the input element. The converting also uses the offset value to apply an offset. The converting further uses the clip maximum and clip minimum values to enforce a maximum value and a minimum value for the output element.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIG. 2 depicts further details of one embodiment of a processor, in accordance with aspects described herein;

FIG. 3A depicts one example of a format of a Neural Network Processing Assist instruction, in accordance with aspects described herein;

FIG. 3B depicts one example of a general register used by the Neural Network Processing Assist instruction, in accordance with aspects described herein;

FIG. 3C depicts one example of another general register used by the Neural Network Processing Assist instruction, in accordance with aspects described herein;

FIG. 3D depicts one example of a parameter block used by a query function of the Neural Network Processing Assist instruction, in accordance with aspects described herein;

FIG. 3E depicts one example of a parameter block used by one or more non-query functions of the Neural Network Processing Assist instruction, in accordance with aspects described herein;

FIG. 3F depicts one example of a tensor descriptor used by the Neural Network Processing Assist instruction, in accordance with aspects described herein;

FIG. 4 depicts an example of a generic 4D-tensor in accordance with aspects described herein;

FIG. 5 depicts an example process for transforming a generic 4D-tensor into a 4D-feature tensor, in accordance with aspects described herein;

FIG. 6 depicts an example of a 4D-feature tensor in accordance with aspects described herein;

FIG. 7 depicts an example process for transforming a generic 4D-tensor into a 4D-kernel tensor, in accordance with aspects described herein;

FIG. 8 depicts an example of a 4D-kernel tensor in accordance with aspects described herein;

FIG. 9 depicts an example process for transforming a generic 4D-tensor into a 4D-weights tensor, in accordance with aspects described herein;

FIG. 10 depicts an example of a 4D-weights tensor in accordance with aspects described herein;

FIG. 11 depicts example quantization processing, in accordance with aspects described herein;

FIG. 12A depicts one example of tensor transformation code of FIG. 1, in accordance with aspects described herein;

FIG. 12B depicts one example of execute instruction code of the tensor transformation code of FIG. 12A, in accordance with aspects described herein;

FIG. 13 depicts an example process for tensor transformation, in accordance with aspects described herein;

FIG. 14A depicts yet another example of a computing environment to incorporate and use one or more aspects described herein; and

FIG. 14B depicts further details of the memory of FIG. 14A, in accordance with one or more aspects described herein.

### DETAILED DESCRIPTION

In accordance with one or more aspects described herein, a capability is provided to facilitate processing within a computing environment, by, for instance, enabling tensor transformation in which an input tensor is reformatted, in which the data-layout format and/or data type of elements of the input tensor are transformed, to provide an output tensor. This is in contrast to, for example, software transformation between tensor formats, which is expensive. As such transformations may be required several times in the processing of a neural network represented by a tensor (e.g., input tensor), the gains to efficiency and reduction in processing time and resources spent is significant.

In one or more aspects, a computer program product is provided. The computer program product includes a set of one or more computer-readable storage media and program instructions, collectively stored in the set of one or more computer-readable storage media, for causing at least one computing device to perform computer operations. The computer operations include executing an instruction. Executing the instruction includes obtaining an input tensor having a first data-layout format and elements of a first data type. Executing the instruction further includes reformatting the input tensor to provide an output tensor having a second data-layout format, the second data-layout being different from the first data-layout format, and elements of a second data type, the second data type being different from the first data type. Using a single instruction to perform the transformation/reformatting saves processing by avoiding software transformation of the tensor in setup for executing other instructions. Avoiding software transformation increases processing speed, reduces use of system resources, and improves performance because of the increased computer efficiency.

Additionally, or alternatively, in one or more embodiments, the executing further includes obtaining from a parameter block specified by the instruction a transformation indicator. The transformation indicator indicates the second data-layout format and the second data type to use in reformatting the input tensor. The reformatting is performed based on the transformation indicator. Providing the transformation indicator provides the instruction with flexibility in going between formats because the input-to-output transformation can be selected from potentially multiple different input-to-output formats. Providing the transformation indicator in a parameter block specified by the instruction has an advantage of avoiding hard-coding the transformation indicator into the instruction; the indicator may be separately modifiable any time prior to instruction execution, and avoids having to recompile the instruction if a change to the transposition indicator (e.g., to specify a different input-to-output transformation) is desired.

Additionally, or alternatively, in one or more embodiments, the first data-layout format includes a tensor format in which elements are provided in increasing memory address order, and the first data type is floating-point type. In one or more embodiments, the second data-layout format includes a fixed-size tensor format in which a dimension of the tensor is a fixed-size and a number of elements arrayed in the dimension is based on the fixed-size and element size. In one or more embodiments the first data type is floating-point type of a first bit length and the second data type is floating-point type of a second bit length that is different from the first bit length. In one or more embodiments the second data type is integer type.

Additionally, or alternatively, in one or more embodiments the first data-layout format includes a fixed-size tensor format in which a dimension of the tensor is a fixed-size and a number of elements arrayed in the dimension is based on the fixed-size and element size, and the first data type is floating-point type. In one or more embodiments, the second data-layout format includes a tensor format in which elements are provided in increasing memory address order, the first data type is floating-point type of a first bit length, and the second data type is floating-point type of a second bit length that is different from the first bit length.

By supporting different tensor formats, including tensor formats (such as row-major and column-major) in which elements are provided in increasing memory address order, and the fixed-size tensor format, and by supporting different data types, including the first data type and/or second data type being floating-point type(s) and optionally being floating-point types of different bit lengths, or the second data type being integer type, the output tensor can be optimally sized, for instance aligning to memory/storage boundaries, for processing by an instruction, for instance a neural network processing instruction.

Additionally, or alternatively, in one or more embodiments the executing further includes obtaining, from a parameter block specified by the instruction, a scale value, an offset value, and a clip maximum value and a clip minimum value for enforcing output values within a specified range. The reformatting includes performing element quantization on input elements of the input tensor. The element quantization performed on an input element of the input tensor includes converting the input element to an output element, of the second data type, as an element of the output tensor. The converting uses the scale value to scale to the input element. The converting also uses the offset value to apply an offset. The converting further uses the clip maximum and clip minimum values to enforce a maximum value and a minimum value for the output element. This has an advantage of enabling factoring with scale, adding/subtracting offsets, and enforcing ranges with maximums and minimums, and avoids software processing to perform those functions separately. Thus, by combining multiple operations (transformation and additional operation(s)) into one function, the number of times a processor is invoked to perform the operations is reduced. Further, the storing of intermediate results into memory or another location externally accessible to one or more processors and the reloading therefrom is avoided, which increases processing speed, reduces use of system resources, and improves performance.

In accordance with one or more aspects, each of the embodiments is separable and optional from one another. Further, embodiments may be combined with one another.

In one or more aspects, a computer system is provided. The computer system includes, for instance, at least one computing device, a set of one or more computer-readable storage media, and program instructions, collectively stored in the set of one or more computer-readable storage media, for causing the at least one computing device to perform computer operations. The computer operations include executing an instruction. Executing the instruction includes obtaining an input tensor having a first data-layout format and elements of a first data type. Executing the instruction further includes reformatting the input tensor to provide an output tensor having a second data-layout format, the second data-layout being different from the first data-layout format, and elements of a second data type, the second data type being different from the first data type. Using a single instruction to perform the transformation/reformatting saves processing by avoiding software transformation of the tensor in setup for executing other instructions. Avoiding software transformation increases processing speed, reduces use of system resources, and improves performance because of the increased computer efficiency.

Additionally, or alternatively, in one or more embodiments, the executing further includes obtaining from a parameter block specified by the instruction a transformation indicator. The transformation indicator indicates the second data-layout format and the second data type to use in reformatting the input tensor. The reformatting is performed based on the transformation indicator. Providing the transformation indicator provides the instruction with flexibility in going between formats because the input-to-output transformation can be selected from potentially multiple different input-to-output formats. Providing the transformation indicator in a parameter block specified by the instruction has an advantage of avoiding hard-coding the transformation indicator into the instruction; the indicator may be separately modifiable any time prior to instruction execution, and avoids having to recompile the instruction if a change to the transposition indicator (e.g., to specify a different input-to-output transformation) is desired.

Additionally, or alternatively, in one or more embodiments, the first data-layout format includes a tensor format in which elements are provided in increasing memory address order, and the first data type is floating-point type. In one or more embodiments, the second data-layout format includes a fixed-size tensor format in which a dimension of the tensor is a fixed-size and a number of elements arrayed in the dimension is based on the fixed-size and element size. In one or more embodiments the first data type is floating-point type of a first bit length and the second data type is floating-point type of a second bit length that is different from the first bit length, or the second data type is integer type.

Additionally, or alternatively, in one or more embodiments the first data-layout format includes a fixed-size tensor format in which a dimension of the tensor is a fixed-size and a number of elements arrayed in the dimension is based on the fixed-size and element size, and the first data type is floating-point type. In one or more embodiments, the second data-layout format includes a tensor format in which elements are provided in increasing memory address order, the first data type is floating-point type of a first bit length, and the second data type is floating-point type of a second bit length that is different from the first bit length.

By supporting different tensor formats, including tensor formats (such as row-major and column-major) in which elements are provided in increasing memory address order, and the fixed-size tensor format, and by supporting different data types, including the first data type and/or second data type being floating-point type(s) and optionally being floating-point types of different bit lengths, or the second data type being integer type, the output tensor can be optimally sized, for instance aligning to memory/storage boundaries, for processing by an instruction, for instance a neural network processing instruction.

Additionally, or alternatively, in one or more embodiments the executing further includes obtaining, from a parameter block specified by the instruction, a scale value, an offset value, and a clip maximum value and a clip minimum value for enforcing output values within a specified range. The reformatting includes performing element quantization on input elements of the input tensor. The element quantization performed on an input element of the input tensor includes converting the input element to an output element, of the second data type, as an element of the output tensor. The converting uses the scale value to scale to the input element. The converting also uses the offset value to apply an offset. The converting further uses the clip maximum and clip minimum values to enforce a maximum value and a minimum value for the output element. This has an advantage of enabling factoring with scale, adding/subtracting offsets, and enforcing ranges with maximums and minimums, and avoids software processing to perform those functions separately. Thus, by combining multiple operations (transformation and additional operation(s)) into one function, the number of times a processor is invoked to perform the operations is reduced. Further, the storing of intermediate results into memory or another location externally accessible to one or more processors and the reloading therefrom is avoided, which increases processing speed, reduces use of system resources, and improves performance.

In accordance with one or more aspects, each of the embodiments is separable and optional from one another. Further, embodiments may be combined with one another.

In one or more aspects, a computer-implemented method is provided. The computer-implemented method includes, for instance, executing an instruction. Executing the instruction includes obtaining an input tensor having a first data-layout format and elements of a first data type. Executing the instruction further includes reformatting the input tensor to provide an output tensor having a second data-layout format, the second data-layout being different from the first data-layout format, and elements of a second data type, the second data type being different from the first data type. Using a single instruction to perform the transformation/reformatting saves processing by avoiding software transformation of the tensor in setup for executing other instructions. Avoiding software transformation increases processing speed, reduces use of system resources, and improves performance because of the increased computer efficiency.

Additionally, or alternatively, in one or more embodiments, the executing further includes obtaining from a parameter block specified by the instruction a transformation indicator. The transformation indicator indicates the second data-layout format and the second data type to use in reformatting the input tensor. The reformatting is performed based on the transformation indicator. Providing the transformation indicator provides the instruction with flexibility in going between formats because the input-to-output transformation can be selected from potentially multiple different input-to-output formats. Providing the transformation indicator in a parameter block specified by the instruction has an advantage of avoiding hard-coding the transformation indicator into the instruction; the indicator may be separately modifiable any time prior to instruction execution, and avoids having to recompile the instruction if a change to the transposition indicator (e.g., to specify a different input-to-output transformation) is desired.

Additionally, or alternatively, in one or more embodiments, the first data-layout format includes a tensor format in which elements are provided in increasing memory address order, and the first data type is floating-point type. In one or more embodiments, the second data-layout format includes a fixed-size tensor format in which a dimension of the tensor is a fixed-size and a number of elements arrayed in the dimension is based on the fixed-size and element size. The first data type is floating-point type of a first bit length and the second data type is floating-point type of a second bit length that is different from the first bit length, or the second data type is integer type.

Additionally, or alternatively, in one or more embodiments the first data-layout format includes a fixed-size tensor format in which a dimension of the tensor is a fixed-size and a number of elements arrayed in the dimension is based on the fixed-size and element size, and the first data type is floating-point type. The second data-layout format includes a tensor format in which elements are provided in increasing memory address order, the first data type is floating-point type of a first bit length, and the second data type is floating-point type of a second bit length that is different from the first bit length.

By supporting different tensor formats, including tensor formats (such as row-major and column-major) in which elements are provided in increasing memory address order, and the fixed-size tensor format, and by supporting different data types, including the first data type and/or second data type being floating-point type(s) and optionally being floating-point types of different bit lengths, or the second data type being integer type, the output tensor can be optimally sized, for instance aligning to memory/storage boundaries, for processing by an instruction, for instance a neural network processing instruction.

Additionally, or alternatively, in one or more embodiments the executing further includes obtaining, from a parameter block specified by the instruction, a scale value, an offset value, and a clip maximum value and a clip minimum value for enforcing output values within a specified range. The reformatting includes performing element quantization on input elements of the input tensor. The element quantization performed on an input element of the input tensor includes converting the input element to an output element, of the second data type, as an element of the output tensor. The converting uses the scale value to scale to the input element. The converting also uses the offset value to apply an offset. The converting further uses the clip maximum and clip minimum values to enforce a maximum value and a minimum value for the output element. This has an advantage of enabling factoring with scale, adding/subtracting offsets, and enforcing ranges with maximums and minimums, and avoids software processing to perform those functions separately. Thus, by combining multiple operations (transformation and additional operation(s)) into one function, the number of times a processor is invoked to perform the operations is reduced. Further, the storing of intermediate results into memory or another location externally accessible to one or more processors and the reloading therefrom is avoided, which increases processing speed, reduces use of system resources, and improves performance.

In accordance with one or more aspects, each of the embodiments is separable and optional from one another. Further, embodiments may be combined with one another.

In one or more aspects, a computer system is provided. The computer system includes at least one hardware accelerator to be used in executing an instruction. Executing the instruction includes obtaining an input tensor having a first data-layout format and elements of a first data type. Executing the instruction also includes obtaining from a parameter block specified by the instruction a transformation indicator. The transformation indicator indicates a second data-layout format and a second data type to use in reformatting the input tensor. Also obtained from the parameter block specified by the instruction is a scale value. Additionally obtained from the parameter block specified by the instruction is an offset value. Further obtained from the parameter block specified by the instruction are a clip maximum value and a clip minimum value for enforcing output values within a specified range. Executing the instruction further includes reformatting the input tensor to provide an output tensor having the second data-layout format, the second data-layout being different from the first data-layout format, and elements of a second data type, the second data type being different from the first data type. The reformatting is performed based on the transformation indicator. The reformatting includes performing element quantization on input elements of the input tensor. The element quantization performed on an input element of the input tensor includes converting the input element to an output element, of the second data type, as an element of the output tensor. The converting uses the scale value to scale to the input element. The converting also uses the offset value to apply an offset. The converting further uses the clip maximum and clip minimum values to enforce a maximum value and a minimum value for the output element. Using a single instruction to perform the transformation/reformatting saves processing by avoiding software transformation of the tensor in setup for executing other instructions. Avoiding software transformation increases processing speed, reduces use of system resources, and improves performance because of the increased computer efficiency. Additionally, providing the transformation indicator provides the instruction with flexibility in going between formats because the input-to-output transformation can be selected from potentially multiple different input-to-output formats. Providing the transformation indicator in a parameter block specified by the instruction has an advantage of avoiding hard-coding the transformation indicator into the instruction; the indicator may be separately modifiable any time prior to instruction execution, and avoids having to recompile the instruction if a change to the transposition indicator (e.g., to specify a different input-to-output transformation) is desired. Further, element quantization has an advantage of enabling factoring with scale, adding/subtracting offsets, and enforcing ranges with maximums and minimums, and avoids software processing to perform those functions separately. Thus, by combining multiple operations (transformation and additional operation(s)) into one function, the number of times a processor is invoked to perform the operations is reduced. Further, the storing of intermediate results into memory or another location externally accessible to one or more processors and the reloading therefrom is avoided, which increases processing speed, reduces use of system resources, and improves performance.

In one or more aspects, a computer-implemented method is provided. The method includes executing an instruction. Executing the instruction includes obtaining an input tensor having a first data-layout format and elements of a first data type. Executing the instruction also includes obtaining from a parameter block specified by the instruction a transformation indicator. The transformation indicator indicates a second data-layout format and a second data type to use in reformatting the input tensor. Also obtained from the parameter block specified by the instruction is a scale value. Additionally obtained from the parameter block specified by the instruction is an offset value. Further obtained from the parameter block specified by the instruction are a clip maximum value and a clip minimum value for enforcing output values within a specified range. Executing the instruction further includes reformatting the input tensor to provide an output tensor having the second data-layout format, the second data-layout being different from the first data-layout format, and elements of a second data type, the second data type being different from the first data type. The reformatting is performed based on the transformation indicator. The reformatting includes performing element quantization on input elements of the input tensor. The element quantization performed on an input element of the input tensor includes converting the input element to an output element, of the second data type, as an element of the output tensor. The converting uses the scale value to scale to the input element. The converting also uses the offset value to apply an offset. The converting further uses the clip maximum and clip minimum values to enforce a maximum value and a minimum value for the output element. Using a single instruction to perform the transformation/reformatting saves processing by avoiding software transformation of the tensor in setup for executing other instructions. Avoiding software transformation increases processing speed, reduces use of system resources, and improves performance because of the increased computer efficiency. Additionally, providing the transformation indicator provides the instruction with flexibility in going between formats because the input-to-output transformation can be selected from potentially multiple different input-to-output formats. Providing the transformation indicator in a parameter block specified by the instruction has an advantage of avoiding hard-coding the transformation indicator into the instruction; the indicator may be separately modifiable any time prior to instruction execution, and avoids having to recompile the instruction if a change to the transposition indicator (e.g., to specify a different input-to-output transformation) is desired. Further, element quantization has an advantage of enabling factoring with scale, adding/subtracting offsets, and enforcing ranges with maximums and minimums, and avoids software processing to perform those functions separately. Thus, by combining multiple operations (transformation and additional operation(s)) into one function, the number of times a processor is invoked to perform the operations is reduced. Further, the storing of intermediate results into memory or another location externally accessible to one or more processors and the reloading therefrom is avoided, which increases processing speed, reduces use of system resources, and improves performance.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa.

Further, it is noted that advantages described or set-forth explicitly or implicitly herein may not be present in all embodiments described herein, and are not necessarily required of all embodiments described herein.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that performs aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as tensor transformation code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

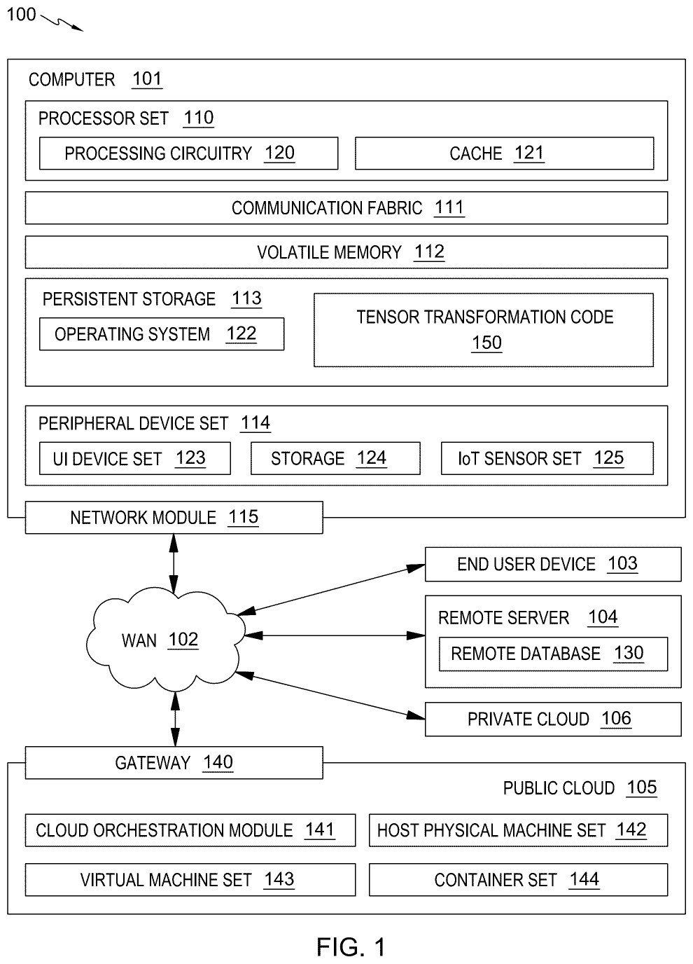

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication Fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral Device Set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network Module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote Server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public Cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud Computing Services and/or Microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. In addition, a processor as used herein could be or incorporate a neural network processor. Other variations are possible.

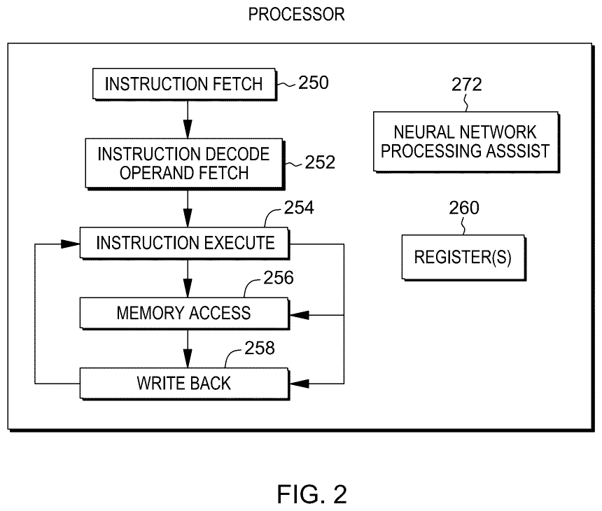

In one example, a processor (e.g., of processor set 110) includes a plurality of functional components (or a subset thereof) used to execute instructions. FIG. 2 depicts further details of one embodiment of a processor, in accordance with aspects described herein. As depicted in FIG. 2, these functional components include, for instance, an instruction fetch component 250 to fetch instructions to be executed; an instruction decode unit 252 to decode the fetched instructions and to obtain operands of the decoded instructions; one or more instruction execute components 254 to execute the decoded instructions; a memory access component 256 to access memory for instruction execution, if necessary; and a write back component 258 to provide the results of the executed instructions. One or more of the components may access and/or use one or more registers 260 in instruction processing. Further, one or more of the components may, in accordance with one or more aspects described herein, include at least a portion of or have access to one or more other components used in performing neural network processing assist processing of, e.g., a Neural Network Processing Assist instruction (or other processing that may use one or more aspects described herein), as described herein. The one or more other components may include, for instance, a neural network processing assist component 272 (and/or one or more other components).

Aspects described herein can be provided as part of architected instruction(s), for instance those of an instruction set architecture. For instance, aspects may be provided as part of, and are described herein in the context of, a Neural Network Processing Assist instruction, although this is for purposes of example only, and not limitation.

A Neural Network Processing Assist instruction is configured to implement multiple functions, which could include a query function and a plurality of non-query functions. The non-query functions include, for instance, functions related to tensor computations. The Neural Network Processing Assist instruction is, for instance, a single instruction (e.g., a single architected hardware machine instruction at the hardware/software interface) that is part of an instruction set architecture (ISA), which is processed (e.g., decoded and/or executed, at least in part) on one or more processors, for example one or more general-purpose processors, one or more special-purpose processors, or a combination of the two. For instance, the instruction is dispatched by a program on a general-purpose processor, which decodes and initiates the instruction. Functions specified by the instruction may be performed by the general-purpose processor and/or a special-purpose processor, such as a co-processor configured for certain functions, that is coupled to or part of the general-purpose processor. Then, the instruction completes on, e.g., the general-purpose processor. In other examples, the instruction is initiated, executed and completed on one or more general-purpose processors or one or more special-purpose processors. An example of a special-purpose processor is a neural network processor.

In one embodiment, the single architected instruction operates, for instance, on main memory and is, for instance, synchronously executed. The main memory may be shared with a special-purpose processor used to execute one or more functions, e.g., one or more non-query functions. The use of shared main memory eliminates a need for costly memory pinning and/or input/output (I/O) operations to communicate with the special-purpose processor. It provides memory coherency, in which caches of the general-purpose processor and special-purpose processor remain coherent. Further, since, in one example, the instruction is executed synchronously, in one example, the processor initiating the instruction provides, during execution of the instruction, information to the special-purpose processor (or another processor) that is executing a function specified by the instruction, but does not perform other work unless there is an interruption of the instruction or the instruction completes.

The Neural Network Processing Assist instruction can implement aspects described herein to provide increased performance compared to previous techniques, such as using many instructions and/or programming a purpose-built processor that may need re-programming for other generations. Executing the Neural Network Processing Assist instruction uses less execution cycles compared to, e.g., a software implementation. Use of the single instruction to perform functions described herein, which could include multiple functions, allows for, e.g., reuse of software over many machine generations with high performance. Each of the functions may be configured as part of the single instruction (e.g., the single architected instruction), reducing use of system resources and complexity, and improving system performance.

Further details relating to executing an instruction, for instance a Neural Network Processing Assist instruction, are now described A Neural Network Processing Assist instruction is obtained by a processor, such as a general-purpose processor and is decoded. The decoded instruction is issued, e.g., on the general-purpose processor. A determination is made as to a function to be performed. In one example, this determination is made by checking a function code field of the instruction, an example of which is described below. The function is then performed.

In one embodiment, performing the function includes determining whether the function is to be performed on a special-purpose processor, such as a neural network processor. For instance, in one example, a query function of the Neural Network Processing Assist instruction is performed on a general-purpose processor and non-query functions are performed on a special-purpose processor. However, other variations are possible. If the function is not to be performed on the special-purpose processor, then in one example, it is performed on the general-purpose processor. However, if the function is to be performed on the special-purpose processor (e.g., it is a non-query function, or in another example, one or more selected functions), then information is provided, e.g., by the general-purpose processor to the special-purpose processor for use in executing the function, such as memory address information relating to tensor data to be used in neural network computations. The special-purpose processor obtains the information and performs the function. After execution of the function is complete, processing returns to the general-purpose processor, which completes the instruction. (In other examples, the instruction may be initiated, executed and completed on one or more general-purpose processors or one or more special-purpose processors. Other variations are possible.)

In some embodiments, the general-purpose and special-purpose processors share memory, such as main memory, providing cache coherency, reducing complexity and improving system performance. Further, in one or more aspects, processing of the instruction by, e.g., the general-purpose processor, includes synchronous execution of the instruction, in which the general-purpose processor, as an example, refrains from performing work other than work related to the instruction, such as providing information, e.g., input data addresses, to the special-purpose processor (or other processor) performing the function. The synchronous execution terminates based, e.g., on completion of the instruction or an interrupt of the instruction.

In some embodiments, the instruction is configured to be interruptible. Thus, in executing the instruction, a determination can be made as to whether a previous execution of the instruction has been interrupted. This is determined, in one example, by checking an indicator, such as, for instance, a continuation flag provided in a parameter block used by the instruction being executed. If the previous execution of the instruction, and thus, the specified function, was interrupted, then, in one example, information stored in a select buffer, such as a continuation state buffer, an example of which is described herein, is used to resume the operation that was interrupted.

Additional details relating to a Neural Network Processing Assist instruction and functions that are supported by the instruction are described herein. In the description herein of the instruction and/or functions of the instruction, specific locations, specific fields and/or specific sizes of the fields are indicated (e.g., specific bytes and/or bits). However, other locations, fields and/or sizes may be provided. Further, although the setting of a bit to a particular value, e.g., one or zero, may be specified, this is only an example. The bit, if set, may be set to a different value, such as the opposite value or to another value, in other examples. Many variations are possible.

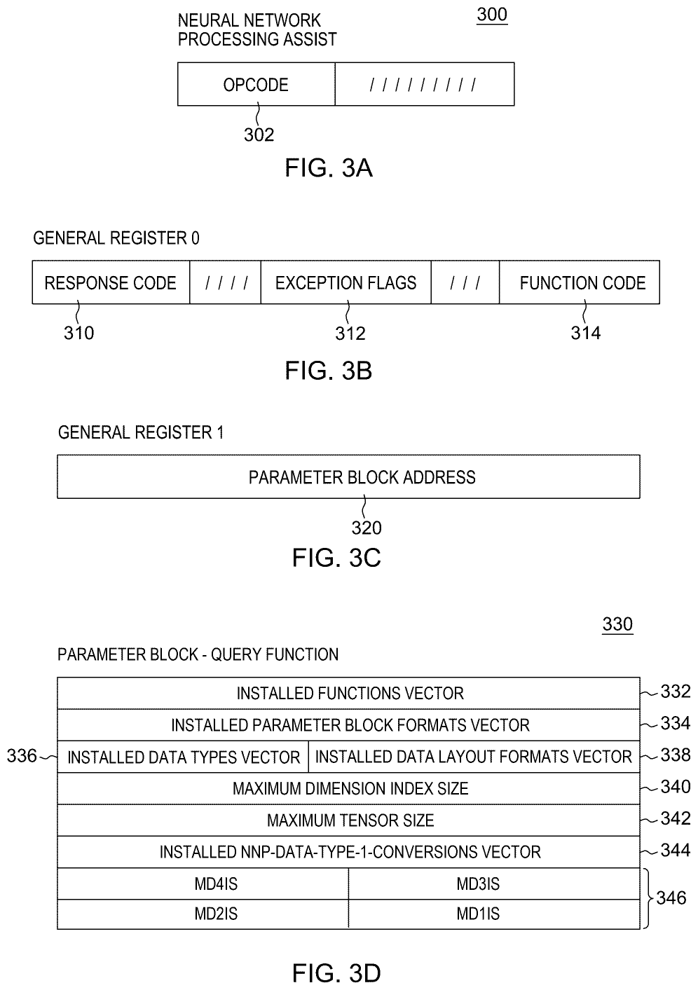

In one example, referring to FIG. 3A, a Neural Network Processing Assist instruction 300 has an RRE format that denotes a register and register operation with an extended operation code (opcode). As shown in FIG. 3A, in one example, Neural Network Processing Assist instruction 300 includes an operation code (opcode) field 302 (e.g., bits 0-15) indicating a neural network processing assist operation, for instance to perform function(s) related to tensor computation. In one example, bits 16-31 of the instruction are reserved and are to contain zeros.

In one example, the instruction uses a plurality of general registers implicitly specified by the instruction. For instance, Neural Network Processing Assist instruction 300 uses implied registers general register 0 and general register 1, examples of which are described with reference to FIGS. 3B and 3C, respectively.

Referring to FIG. 3B, in one example, general register 0 includes a function code field specifying a function code that determines the function to be performed by the instruction. Upon completion of the instruction, general register 0 contains status/exception flags and a response code that may be updated under certain conditions. As an example, general register 0 includes a response code field 310 (e.g., bits 0-15), an exception flags (or status flags) field 312 (e.g., bits 24-31), and a function code field 314 (e.g., bits 56-63). Further, in one example, bits 16-23 and 32-55 of general register 0 are reserved and are to contain zeros. One or more fields are used by a particular function performed by the instruction. Not all fields are used by all of the functions, in one example. Each of the example fields is described below:

Response Code (RC) 310: This field (e.g., bit positions 0-15) contains the response code. When execution of the Neural Network Processing Assist instruction completes with a condition code of, e.g., one, a response code is stored. When an invalid input condition is encountered, a non-zero value is stored to the response code field, which indicates the cause of the invalid input condition recognized during execution and a selected condition code, e.g., 1, is set. In some embodiments, response codes less than a defined value, for instance F000 hex, apply to all NNPA functions unless the function description states otherwise. The codes stored to the response code field are defined, as follows, in one example:

| Response Code | Meaning |
|---|---|
| 0001 | The format of the parameter block, as specified by the |
| | parameter block version number, is not supported by |
| | the model or by the specified function. |
| 0002 | The specified function is not defined or installed on the |
| | machine. |
| 0010 | A specified tensor data layout format is not supported. |
| 0011 | A specified tensor data type is not supported. |
| 0012 | A specified single tensor dimension is greater than the |
| | maximum dimension index size (MDIS) or the |
| | maximum-dimension-n-index size (MDnIS). |
| 0013 | The size of a specified tensor is greater than the |
| | maximum tensor size (MTS). |
| 0014 | The specified tensor address is not aligned on a |
| | 4K-byte boundary. |
| 0015 | The function-specific-save-area-address is not aligned |
| | on a 4K-byte boundary. |
| F000-FFFF | Function specific response codes. These response codes |
| | are defined for certain functions. |

In embodiments, there may be a specified priority at which normal and exceptional conditions are recognized by the NNPA instruction. For cases where multiple response codes may be applicable, it may be model dependent which response code is indicated.

Exception Flags (EF) 312 (Exception Flags may be interchangeably referred to herein as Status Flags (SF), and “Exception” may be interchangeably referred to herein as “Status”): This field (e.g., bit positions 24-31) includes the status flags. If an exception condition is detected during execution of the instruction, the corresponding exception flag control (e.g., bit) will be set to, e.g., one; otherwise, the control remains unchanged. The field (e.g., 312) is to be initialized to zero prior to the first invocation of the instruction. In examples, the field is initialized to zero prior to the beginning of a sequence of NNPA operations to accumulate the status across all operations of the sequence. Reserved flags are unchanged during execution of the instruction. The flags stored to the exception flags field are defined as follows, in one example:

| SF (Bit) | Meaning |
|---|---|
| 0 | Range Violation: This flag is set (e.g., to 1) when a |
| | non-numeric value was either detected in an input |
| | tensor or stored to the output tensor. This flag is, e.g., |
| | only valid when the instruction completes with |
| | condition code, e.g., 0. |
| 1-7 | Reserved. |

Function Code (FC) 314: This field (e.g., bit positions 56-63) includes the function code. Various function codes are assigned function codes for the Neural Network Processing Assist instruction. All other function codes are unassigned. If an unassigned or uninstalled function code is specified, a response code of, e.g., 0002 hex and a select condition code, e.g., 1, are set in general register 0. This field is not modified during execution.

As indicated, in addition to general register 0, the Neural Network Processing Assist instruction also uses general register 1, an example of which is depicted in FIG. 3C. As examples, bits 40-63 in the 24-bit addressing mode, bits 33-63 in the 31-bit addressing mode, or bits 0-63 in the 64-bit addressing mode include an address of a parameter block 320. The contents of general register 1 specify, for instance, a logical address of a leftmost byte of the parameter block in storage. The parameter block is to be designated on a doubleword boundary; otherwise, a specification exception is recognized. For all functions, the contents of general register 1 are not modified.

In the access register mode, access register 1 specifies an address space containing the parameter block, input tensors, output tensors and the function specific save area, as an example.

In one example, the parameter block may have different formats depending on the function specified by the instruction to be performed. For instance, a query function of the instruction can have a parameter block of one format and other functions of the instruction can have a parameter block of another format. In another example, all functions can use the same parameter block format. Other variations are also possible.

As examples, a parameter block and/or the information in the parameter block is stored in memory, in hardware registers, and/or in a combination of memory and/or registers. Other examples are also possible.

One example of a parameter block used by a function, such as a query function, such as the NNPA-Query Available Functions (QAF) operation, is described with reference to FIG. 3D. The NNPA-QAF (query) function can provide the means of indicating the availability of all installed functions, installed parameter-block formats, installed data types, installed data-layout formats, maximum-dimension-index size, and maximum-tensor size, as examples. As shown, in one example, a NNPA-Query Available Functions parameter block 330 includes, for instance:

Installed Functions Vector 332: This field (e.g., bytes 0-31) of the parameter block includes the installed functions vector. In one example, bits 0-255 of the installed functions vector correspond to function codes 0-255, respectively, of the Neural Network Processing Assist instruction. When a bit is, e.g., one, the corresponding function is installed; otherwise, the function is not installed.

Installed Parameter Block Formats (IPBF) Vector 334: This field (e.g., bytes 32-47) of the parameter block includes the installed parameter block formats vector. In one example, bits 0-127 of the installed parameter block formats vector correspond to parameter block formats 0-127 for the non-query functions of the Neural Network Processing Assist instruction. When a bit is, e.g., one, the corresponding parameter block format is installed; otherwise, the parameter block format is not installed.

Installed Data Types Vector 336: This field (e.g., bytes 48-49) of the parameter block includes the installed data types vector. In one example, bits 0-15 of the installed data types vector correspond to the data types being installed. When a bit is, e.g., one, the corresponding data type is installed; otherwise, the data type is not installed. Example data types include (additional, fewer and/or other data types are possible):

| Bit | Data Type |
|---|---|
| 0 | NNP-data-type-1 |
| 1-5 | Reserved |
| 6 | 32-bit binary-floating-point (BFP short) format |
| 7 | Reserved |
| 8 | 8-bit signed or unsigned binary integer |
| 9 | Reserved |
| 10 | 32-bit signed or unsigned binary integer |
| 11-15 | Reserved |

It is noted that binary-floating-point (BFP) may be a term used for the equivalent IEEE 754 floating-point value, e.g., IEEE 32-bit floating-point.

The NNP-data-type-1 format represents a 16-bit signed floating-point number are a format with a range and precision tailored toward neural-network processing.

In embodiments, not all installed-data types may be available to all NNPA functions. In embodiments, an installed-data type does not distinguish between whether the data type is signed or unsigned.

Installed Data Layout Formats Vector 338: This field (e.g., bytes 52-55) of the parameter block includes the installed data layout formats vector. In one example, bits 0-31 of the installed data layout formats vector correspond to data layout formats being installed. When a bit is, e.g., one, the corresponding data layout format is installed; otherwise, the data layout format is not installed. Example data layout formats include (additional, fewer and/or other data layout formats are possible):

| Bit | Data Layout Format |
|---|---|
| 0 | 4D-feature tensor |
| 1 | 4D-kernel tensor |
| 2 | 4D-weights tensor |
| 3-30 | Reserved |
| 31 | 4D-generic tensor |

In embodiments, not all installed data-layout formats are available to all NNPA functions.

Maximum Dimension Index Size 340: This field (e.g., bytes 60-63) of the parameter block includes, e.g., a 32-bit unsigned binary integer that specifies a maximum number of elements in a specified dimension index size for any specified tensor. In another example, the maximum dimension index size specifies a maximum number of bytes in a specified dimension index size for any specified tensor. Other examples are also possible.

The MDIS value is applicable when parameter-block-format 1 is not installed, and it applies to all dimensions of a tensor. When parameter-block-format 1 is installed, the individual maximum-dimension-n-index-size (MDnIS) values are applicable, as described below; in this case, MDIS contains the minimum of the MDnIS values.

Maximum Tensor Size 342: This field (e.g., bytes 64-71) of the parameter block includes, e.g., a 64-bit unsigned binary integer that specifies a maximum number of bytes in any specified tensor including any pad bytes required by the tensor format. In another example, the maximum tensor size specifies a maximum number of total elements in any specified tensor including any padding required by the tensor format. Other examples are also possible.

Installed-NNP-Data-Type-1-Conversions Vector 344: This field (e.g., bytes 72-73) of the parameter block includes the installed-NNP-Data-Type-1-conversions vector. In one example, bits 0-15 of the installed-NNP-Data-Type-1-conversions vector correspond to installed data type conversions between binary-floating point (BFP) and NNP-data-type-1 formats. When a bit is one, the corresponding conversion is installed; otherwise, the conversion is not installed. Additional, fewer, and/or other conversions may be specified.

| Bit | Data Type |
|---|---|
| 0 | Reserved |
| 1 | BFP tiny format (16 bit) |
| 2 | BFP short format (32 bit) |
| 3-15 | Reserved |

Maximum-Dimension-n-Index-Sizes (MDnIS) 346: These fields (e.g., bytes 88-103) contain four unsigned integers, e.g. of 4-bytes each, that specify the maximum number of elements in each dimension of a tensor, as follows:

| Field | Bytes | Contents |
|---|---|---|
| MD4IS | 88-91 | Maximum dimension-4 index size |
| MD3IS | 92-95 | Maximum dimension-3 index size |
| MD2IS | 96-99 | Maximum dimension-2 index size |
| MD1IS | 100-103 | Maximum dimension-1 index size |

The MDnIS fields may be stored and are applicable only when parameter-block format 1 or higher is installed; otherwise, zeros may be stored in bytes 88-103. When applicable, an individual MDnIS value may never be less than the MDIS value.

Although one example of a parameter block for a query function is described with reference to FIG. 3D, other formats of a parameter block for a query function, including the NNPA-Query Available Functions operation, may be used. The format may depend, in one example, on the type of query function to be performed. Further, the parameter block and/or each field of the parameter block may include additional, fewer and/or other information.

In addition to the parameter block for a query function, in one example, there is a parameter block format for non-query functions, such as non-query functions of the Neural-Network Processing Assist instruction. One example of a parameter block used by a non-query function, such as a non-query function of the Neural Network Processing Assist instruction, is described with reference to FIG. 3E.

As shown, in one example, a parameter block 350 employed by, e.g., the non-query functions of the Neural Network Processing Assist instruction includes, for instance:

Parameter Block Version Number 352: The parameter block 350 can include (e.g., via bits 9-15) a 7-bit (in this example) unsigned binary integer specifying the format of the parameter block. A query function can provide a mechanism of indicating the parameter block formats available. When the format of the parameter block specified is not supported by the model, a response code of, e.g., 0001 hex is set in general register 0 and the instruction completes by setting a condition code, e.g., condition code 1. The parameter block version number is specified by the program and is not modified during the execution of the instruction.

Model Version Number 354: This field (e.g., byte 2) of the parameter block is an unsigned binary integer (e.g., an 8-bit unsigned binary integer) identifying the model which executed the instruction (e.g., the particular function). When a continuation flag (described below) is set (e.g., to one), the model version number may be an input to the operation for the purpose of interpreting the contents of a continuation state buffer field (described below) of the parameter block to resume the operation.

Continuation Flag 356: This field (e.g., bit 63) of the parameter block, when, e.g., one, indicates the operation is partially complete and the contents of the continuation state buffer may be used to resume the operation. The program is to initialize the continuation flag to zero and not modify the continuation flag in the event the instruction is to be re-executed for the purpose of resuming the operation; otherwise, results are unpredictable.

If the continuation flag is set at the beginning of the operation and the contents of the parameter block have changed since the initial invocation, results are unpredictable and may include recognition of a general-operand data exception.

Function-specific-save-area-address 358: This field (e.g., bytes 56-63) of the parameter block includes the logical address of the function specific save area. In one example, the function-specific-save-area-address is to be aligned on a 4 K-byte boundary; otherwise, a response code of, e.g., 0015 hex is set in general register 0 and the instruction completes with a condition code of, e.g., 1. The address is subject to the current addressing mode. The size of the function specific save area depends on the function code.

When the entire function specific save area overlaps the program event recording (PER) storage area designation, a PER storage alteration event is recognized, when applicable, for the function specific save area. When only a portion of the function specific save area overlaps the PER storage area designation, it is model-dependent which of the following occurs:
A PER storage alteration event is recognized, when applicable, for the entire function specific save area.
A PER storage alteration event is recognized, when applicable, for the portion of the function specific save area that is stored.

When the entire parameter block overlaps the PER storage area designation, a PER storage alteration event is recognized, when applicable, for the parameter block. When only a portion of the parameter block overlaps the PER storage area designation, it is model-dependent which of the following occurs:
A PER storage alteration event is recognized, when applicable, for the entire parameter block.
A PER storage alteration event is recognized, when applicable, for the portion of the parameter block that is stored.

A PER zero-address detection event is recognized, when applicable, for the parameter block. Zero address detection does not apply to the tensor addresses or the function-specific-save-area-address, in one example.

Continuing with the description of example parameter block 350, the parameter block includes tensor descriptors for input tensors and output tensors. In this example, there are tensor descriptors for two output tensors and three input tensors. Different functions might utilize a different number of input tensors and/or output tensors. If a tensor descriptor is not used by a particular function, then the descriptor can be ignored.

Output Tensor Descriptors (e.g., 1-2) 360/Input Tensor Descriptors (e.g., 1-3) 365: One example of a tensor descriptor is described with reference to FIG. 3F. In one example, a tensor descriptor 360, 365 includes, referring to FIG. 3F:

Data Layout Format 382: This field (e.g., byte 0) of the tensor descriptor contains, e.g., an 8-bit unsigned binary integer specifying the data layout format. Valid data layout formats include, for instance (additional, fewer and/or other data layout formats are possible):

| Format | Description | Alignment (bytes) |
|---|---|---|
| 0 | 4D-feature tensor | 4096 |
| 1 | 4D-kernel tensor | 4096 |
| 2 | 4D-weights tensor | 4096 |
| 3-30 | Reserved | — |
| 31 | 4D-generic tensor | 4096 |
| 32-255 | Reserved | — |

When the alignment of a data-layout format is based on the data type, the alignment can be an integral boundary based on the size in bytes of a data element. For example, for a 4D-generic tensor having a BFP-short-format data type, the alignment is four bytes.

If an unsupported or reserved data layout format is specified, the response code of, e.g., 0010 hex, is set in general register 0 and the instruction completes by setting condition code, e.g., 1.

Data Type 384: This field (e.g., byte 1) contains, e.g., an 8-bit unsigned binary integer specifying the data type of the tensor. Examples of supported data types are described below (additional, fewer and/or other data types are possible):

| Value | Data Type | Data Size (bits) |
|---|---|---|
| 0 | NNP data-type-1 | 16 |
| 1-5 | Reserved | — |
| 6 | BFP short format | 32 |
| 7 | Reserved | — |
| 8 | Signed binary integer | 9 |
| 9 | Reserved | — |
| 10 | Signed or unsigned binary integer | 32 |
| 11-255 | Reserved | — |

If an unsupported or reserved data type is specified, a response code of, e.g., 0011 hex is set in general register 0 and the instruction completes by setting condition code, e.g., 1.

Dimension 1-4 Index Size 386: Collectively, dimension index sizes one through four specify the shape of a 4D tensor, each in the form of, e.g., a 32-bit unsigned binary integer. Each dimension index size is to be greater than zero and less than or equal to the maximum dimension index size (MDIS) (340, FIG. 3D); otherwise, a response code of, e.g., 0012 hex is set in general register 0 and the instruction completes by setting condition code, e.g., 1. In embodiments in which transformation function(s) are installed, for instance a function to transform between data-layout-formats, such as to transform a data-layout-format-31 tensor to or from a data-layout-format-0 4D-feature tensor as an example, the size of the transformed tensor (e.g., in data-layout-format 0 or data-layout-format 1) is to be less than or equal to a maximum tensor size (342, FIG. 3D); otherwise, a response code, e.g., 0013 hex is set in general register 0 and the instruction completes by setting condition code, e.g., 1.

Tensor Address 388: This field (e.g., bytes 24-31) of the tensor descriptor includes a logical address of the leftmost byte of the tensor. The address is subject to the current addressing mode.

If the tensor descriptor is used by the function, then if the address is not aligned on the boundary of the associated data layout format, a response code of, e.g., 0014 hex, is set in general register 0 and the instruction completes by setting condition code, e.g., 1.

The address is subject to the current addressing mode. In the access register mode, access register 1 specifies the address space containing all active input and output tensors in storage.

Returning to FIG. 3E, parameter block 350 further includes, in one example, function-specific-parameters (370), which may be used by specific functions, as described herein. The parameter block could contain any number n of function specific parameters, as shown by FSPs 1 through n. In specific embodiments, the architecture defines sixteen FSPs (FSP 1 through FSP 16), and thus n is 16. Different functions could use different FSPs and different numbers of FSPs, and it may be that not all defined FSPs are used. If a function does not need all function-specific-parameter fields, the unused fields could contain zeros, as an example. In addition, the number of FSPs used for a given function could have an association to the parameter-block-version number (PBVN). For instance, in some embodiments, when PBVN is zero then only FSPs 1-5 are meaningful, and when PBVN>0, then any one or more of FSPs 1-16 may be used.

Further, parameter block 350 includes, in one example, a continuation state buffer field 375, which includes data (or a location of data) to be used if operation of this instruction is to be resumed. In examples, the continuation state buffer field 375 holds intermediate results for partial completion reported by setting the condition code equal to a value, e.g., 3.

As an input to the operation, reserved fields of the parameter block should contain zeros. When the operation ends, reserved fields may be stored as zeros or remain unchanged.

Although one example of a parameter block for a function, such as a non-query function, is described with reference to FIG. 3E, other formats of a parameter block for a non-query function, including a non-query function of the Neural Network Processing Assist instruction, may be used. The format may depend, in one example, on the type of function to be performed. Further, although one example of a tensor descriptor is described with reference to FIG. 3E, other formats may be used. Further, different formats for input and output tensors may be used. Other variations are possible.

As noted, the Neural Network Processing Assist (NNPA) query function provides a mechanism to indicate selected information, such as, for instance, the availability of installed functions, installed parameter block formats, installed data types, installed data layout formats, maximum dimension index size and maximum tensor size. In execution of one embodiment of the query function, a processor, such as general-purpose processor, obtains information relating to a specific processor, such as a specific model of a neural network processor, such as neural network processor. A specific model of a processor or machine has certain capabilities. Another model of the processor or machine may have additional, fewer and/or different capabilities and/or be of a different generation (e.g., a current or future generation) having additional, fewer and/or different capabilities. The obtained information is placed in a parameter block (e.g., parameter block 330) or other structure that is accessible to and/or for use with one or more applications that may use this information in further processing. In one example, the parameter block and/or information of the parameter block is maintained in memory. In other embodiments, the parameter block and/or information may be maintained in one or more hardware registers. As another example, the query function may be a privileged operation executed by the operating system, which makes available an application programming interface to make this information available to the application or non-privileged program. In yet a further example, the query function is performed by a special-purpose processor, such as neural network processor. Other variations are possible.

The information is obtained, e.g., by the firmware of the processor executing the query function. The firmware has knowledge of the attributes of the specific model of the specific processor (e.g., neural network processor). This information may be stored in, e.g., a control block, register and/or memory and/or otherwise be accessible to the processor executing the query function.

The obtained information includes, for instance, model-dependent detailed information regarding at least one or more data attributes of the specific processor, including, for instance, one or more installed or supported data types, one or more installed or supported data layout formats and/or one or more installed or supported data sizes of the selected model of the specific processor. This information is model-dependent in that other models (e.g., previous models and/or future models) may not support the same data attributes, such as the same data types, data sizes and/or data layout formats. When execution of the query function (e.g., NNPA-QAF function) completes, condition code 0, as an example, is set. Condition codes 1, 2 and 3 are not applicable to the query function, in one example.

As indicated, in one example, the obtained information includes model-dependent information about one or more data attributes of, e.g., a particular model of a neural network processor. One example of a data attribute is installed data types of the neural network processor. For instance, a particular model of a neural network processor (or other processor) may support one or more data types, such as a NNP-data-type-1 data type (also referred to as a neural network processing-data-type-1 data type) and/or other data types, as examples. The NNP-data-type-1 data type is a 16-bit floating-point format that provides a number of advantages for deep learning training and inference computations

Although the NNP-data-type-1 data type is supported in one example, other specialized and non-standard data types may be supported, as well as one or more standard data types including, but not limited to: IEEE 754 short precision, binary floating-point 16-bit, IEEE half precision floating point, 8-bit floating point, 4-bit integer format and/or 8-bit integer format, to name a few. These data formats have different qualities for neural network processing. As an example, smaller data types (e.g., less bits) can be processed faster and use less cache/memory, and larger data types provide greater result accuracy in the neural network. A data type to be supported may have one or more assigned bits in the query parameter block (e.g., in installed data types field 336 of parameter block 330). For instance, specialized or non-standard data types supported by a particular processor are indicated in the installed data types field but standard data types are not indicated. In other embodiments, one or more standard data types are also indicated. Other variations are possible.

In embodiments, an 8-bit signed binary integer (INT8) data format is supported. Certain NNPA functions use the 8-bit signed binary integer data format having a range of −128 to +127. Arithmetic operations that result in an 8-bit signed binary integer are saturating; that is, if the result is less than −128, it is set to −128, and if the result is greater than +127, it is set to +127.

In one example, the query function obtains an indication of the data types installed on the model-dependent processor and places the indication in the parameter block by, e.g., setting one or more bits in installed data types field 336 of parameter block 330. Further, in one example, the query function obtains an indication of installed data layout formats (another data attribute) and places the information in the parameter block by, e.g., setting one or more bits in installed data layout formats field 338. Example data layout formats include, for instance, a 4D-feature tensor layout, a 4D-kernel tensor layout, and a 4D-weights tensor layout (i.e., data-layout format 2). Others are possible. The 4D-feature tensor layout is used, in one example, by the functions described herein, and in one example, the convolution function uses the 4D-kernel tensor layout. These data layout formats arrange data in storage for a tensor in a way that increases processing efficiency in execution of the functions of the Neural Network Processing Assist instruction. For instance, to operate efficiently, the Neural Network Processing Assist instruction uses input tensors provided in particular data layout formats. Although example layouts are provided, additional, fewer and/or other layouts may be provided for the functions described herein and/or other functions.

The use or availability of layouts for a particular processor model is provided by the vector of installed data layout formats (e.g., field 338 of parameter block 330). The vector is, for instance, a bit vector of installed data layout formats that allows the CPU to convey to applications which layouts are supported. In one example, the bit vector of installed data layout formats is configured to represent up to 16 data layouts, in which a bit is assigned to each data layout. However, a bit vector in other embodiments may support more or fewer data layouts. Further, a vector may be configured in which one or more bits are assigned to data layouts. Many examples are possible.

In one example, the Neural Network Processing Assist instruction operates with 4D-tensors, meaning tensors with 4 dimensions. These 4D-tensors are obtained from generic input tensors in row-major format, meaning that, when enumerating the tensor elements in increasing storage-address order, the inner dimension called E1 will be stepped up/incremented first through the E1-index-size values starting with 0 through the E1-index-size-1, before the index of the E2 dimension will be increased and the stepping through the E1 dimension is repeated. The index of the outer dimension called the E4 dimension is increased last. As one alternative to the row-major format, another format in which elements are provided in increasing memory address order is a ‘column-major’ formatted tensor format, which may be another example of a generic format. For a generic input tensor in column-major format, when enumerating the tensor elements in increasing storage-address order, the column dimension (e.g., E2) will be stepped up/incremented first through the E2-index-size values starting with 0 through the E2-index-size-1, before the index of another dimension, such as the row (E1) dimension, will be increased, and then stepping through the E2 dimension is repeated. The index of the outer dimension (e.g., E4 dimension) is increased last. Both the row-major format and the column-major format are examples of a tensor format in which elements are provided in increasing memory address order.

Tensors that have a lower number of dimensions (e.g., 3D-, 2D, or 1D-tensors) will be represented as 4D-tensors the index size of the unused dimensions set to 1.

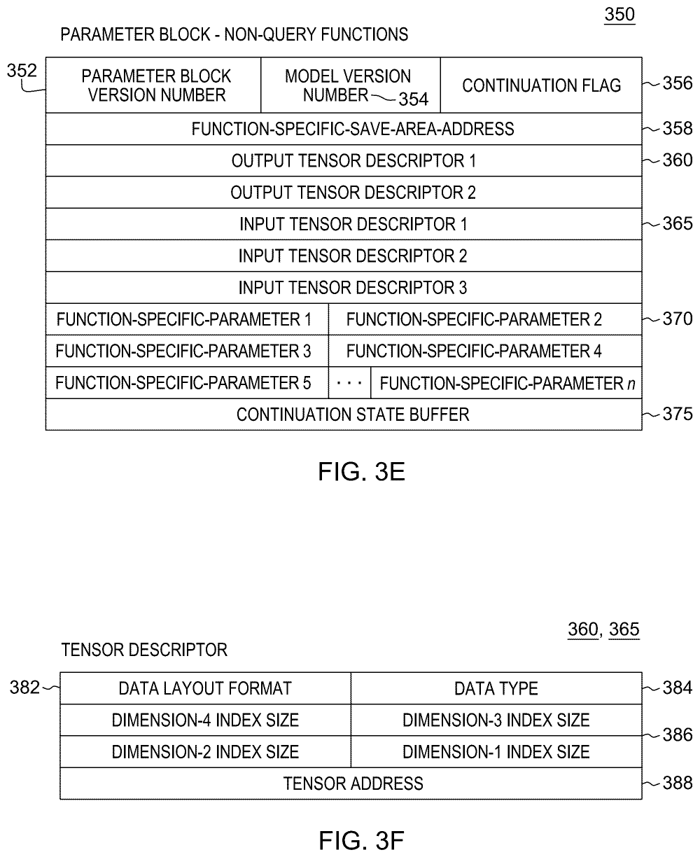

An example of a generic tensor is shown in FIG. 4. The four dimensions of the tensor are denoted E4, E3, E2, and E1. Each element of the tensor (shown as integers starting at value 0) is contiguous in storage. As an example, the element [1][0][2][1] is the value 67.

The row-format generic tensor, such as that of FIG. 4, is considered to be in data-layout-format 31, discussed elsewhere herein. In embodiments in which transformation function(s) are installed, for instance a function to transform between data-layout-formats, this can be used to transform a data-layout-format-31 generic tensor to and from a data-layout-format-0 4D-feature tensor.

Sticks, Stickification, and Elements Per Stick (eps): Tensors that have been transformed into any of one or more specific layouts, such as an NNP data layout—that is, tensors that have been structured such that the E1 and E2 dimensions are optimally sized for processing by the NNPA instruction—are referred to as “stickified” tensors, meaning their E1 dimensions, referred to as “sticks”, are of a fixed size. In some examples, the fixed-size is derived from a Single Instruction, Multiple Data (SIMD) path width in the hardware, though this is by way of example only, and not limitation. This provides a ‘tile’-like format that organizes the elements in fixed-size width vectors grouped/arrayed by a fixed-size number of these vectors. Conversely, generic tensors that have not been transformed may be referred to as “unstickified” tensors. In example processor models, the size of a stick (“stick size” or “stick_size”) is, e.g., 128 bytes.

In some data-layout-formats, such as data-layout-formats 0, 1, and 2 discussed herein, the maximum number of elements per stick (eps) is determined based on the stick size and the size of the elements (“element size” or “element_size”) as follows:

$$eps = stick\_size / element\_size$$

In examples, the element size is derived from the data type. The elements per stick for example data types are shown by Table 1:

TABLE 1

| Data Type | | | Elements Per |
|---|---|---|---|
| Code | Name | Size (bytes) | Stick (eps) |
| 0 | NNP Data-Type 1 | 2 | 64 |
| 6 | 32-bit BFP-short format | 4 | 32 |
| 8 | 8-bit signed binary integer | 1 | 128 |
| 10 | 32-bit binary integer | 4 | 32 |

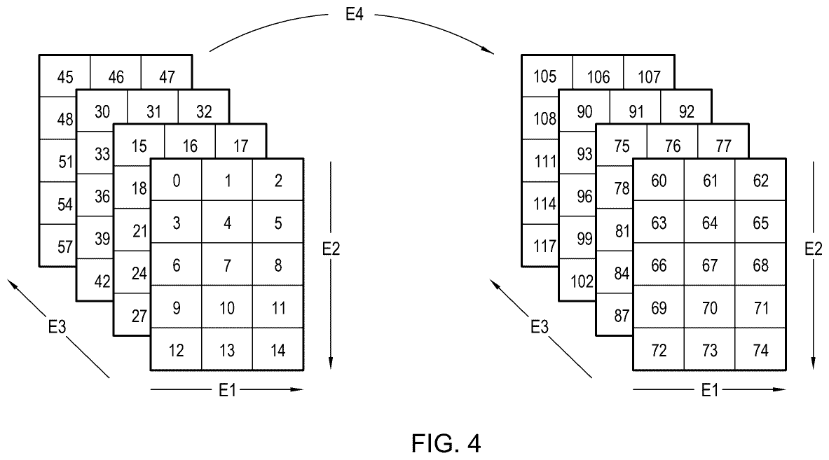

Data-Layout-Format-0: A process for the transformation of a row-major generic 4D-tensor with dimensions E4, E3, E2, E1 (an example of which is depicted by FIG. 4) into an NNPA data-layout-format-0 4D-feature tensor (also referred to herein as NNPA data layout format 0 4D-feature tensor) is depicted by FIG. 5. The process begins with setting (502) e2_limit=┌E2/32┐*32, e1_limit=┌E1/eps┐*eps, and e4x=0. ┌n┐ or ceil(n) refers to the ceiling (or “ceil”) function, that is an integer result with no fraction, and is taken as the smallest integer larger or equal to n. It is determined at 504 whether e4x<E4, and if not (504, F), the process ends. Otherwise (504, T), the process sets (506) e3x=0 and determines (508) whether e3x<E3. If not (508, F), the process sets (510) e4x=e4x+1 and returns to 504. Otherwise (508, T), the process sets (512) e2x=0 and determines (514) whether e2x<e2_limit. If not (514, F), the process sets (516) e3x=e3x+1 and returns to 508. Otherwise (514, T), the process sets (518) e1x=0, then determines (520) whether e1x<e1_limit. If not (520, F), the process sets (522) e2x=e2x+1 and returns to 514. Otherwise (520, T), the process sets arr_stick_pos=(E3*e2_limit*e1_limit*e4x)+(e2_limit*e3x*eps)+(e2x*eps)+(└e1x/eps┘*e2_limit*E3*eps)+(e1x MOD eps). └n┘ or floor(n) refers to the floor function, that is an integer result with no fraction, and is taken as the greatest integer less than or equal to n. Mod or MOF is modulo. The process continues by determining (526) whether e2x<E2. If not (526, F), the process sets (538) value=E2_pad. If instead at 526 it is determined that e2x is less than E2 (526, T), the process determines (528) whether e1x<E1. If not (528, F), the process sets (530) value=E1_pad. Otherwise, (528, T), the process sets (536) value=input_array [e4x][e3x][e2x][e1x]. After a value is set (either by 530, 536, or 538), the process continues by setting (532) OutputTensor [arr_stick_pos]=value, setting (534) e1x=e1x+1, then returning to 520.

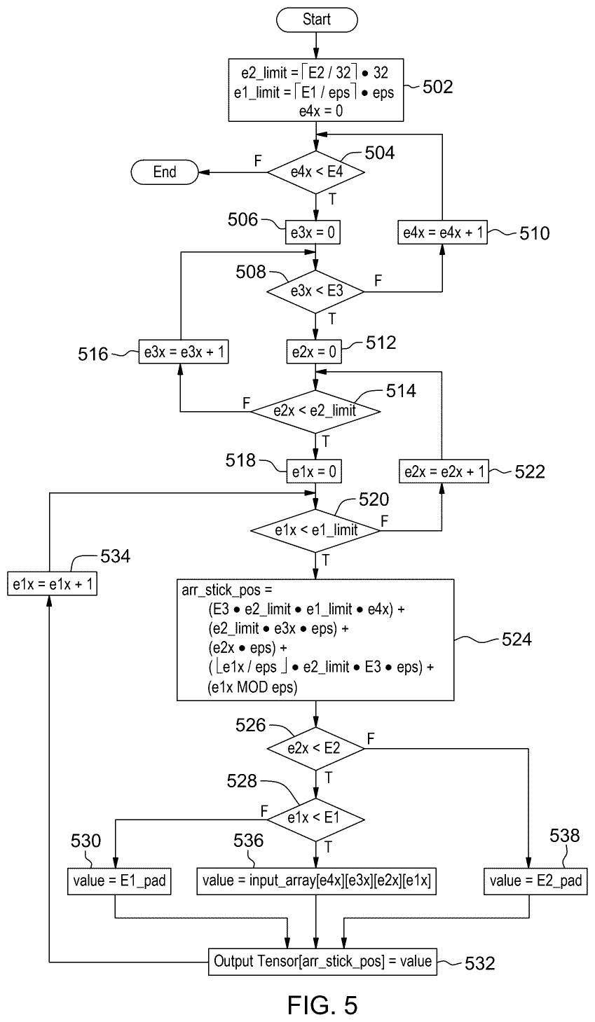

An example of a NNPA data-layout-format-0 4D-feature tensor is depicted by FIG. 6. The feature tensor of FIG. 6 has dimensions E4, ┌E1/eps┐, E3, ┌E2/32┐*32, eps. As an example, the element [1][0][0][2][1] is the value 67. Cells labeled E1-Pad are E1 padding, while cells labeled E2-Pad are E2 padding. eps refers to elements per stick, for example 64 for NNP-data-type 1, and 128 for INT8. As noted, [n] refers to the ceil function.

Thus, a resulting transformed generic tensor can be represented, for instance, as a 4D-tensor of eps-element vectors, for instance 64-element vectors as an example, or a 5D-tensor with dimensions:

E4, ┌E1/eps┐, E3, ┌E2/32┐*32, eps. Another way of stating the preceding in examples is: E4*E3*ceil (E2/32)*32*ceil (E1/eps)*eps elements.

The total size, in elements of the resulting tensor, is the product of these five dimensions.

An element [e4][e3][e2][e1] of the generic tensor may be mapped to the following element of the resulting 5D-tensor:

[e4][[e1/eps]][e3][e2][e1 MOD eps], where └ ┘ is the floor function and mod is modulo. Another way of stating the preceding in examples is: element (E3*e2_limit*e1_limit*e4x)+(e2_limit*e3x*eps)+(e2x*eps)+(└e1x/eps┘*e2_limit*E3*eps)+(e1x mod eps), where e2_limit=┌E2/32┐*32 and e1_limit=┌E1/eps┐*eps.)

The resulting tensor may have more elements than the generic tensor. Elements of the resulting tensor with no corresponding elements in the generic tensor are called pad elements.

Consider the element [fe4][fe1][fe3][fe2][fe0] of a NNPA data layout format 0 4D-feature tensor of a eps-element vectors or its equivalent representation as a 5D-tensor of elements. This element is either a pad element or its corresponding element in the generic 4D tensor with dimensions E4, E3, E2, E1 can be determined with the following formula:

```
  if fe2 ≥ E2 then this is an E2 (or page)-pad element
  else if fe1*eps+fe0 ≥ E1 then this is an E1 (or row)-pad element
  else the indices of the corresponding element in the generic 4D tensor are:
[fe4][fe3][fe2][fe1*eps+fe0]
```

Alternatively, consider the element at offset dlf0_off of an NNPA data layout format 0 4D-feature tensor. This element is either a pad element or its corresponding element in the generic 4D-tensor with dimensions E4, E3, E2, E1 and can be determined as follows:

```
  if dlf0_off MOD (┌E1/32┐ * 32 * eps) ≥ E2 * eps then this is an
E2-pad element
  else:
  - area3d = E3*┌E2/32┐*32*┌E1/eps┐*eps
  - rem3d = dlf0_off MOD area3d
  - if (└rem3d/ (E3 * ┌E2/32┐ * 32 * eps)┘ == └E1/
eps┘ AND rem3d MOD eps ≥ E1 MOD eps) then this is an E1-pad
element.
  else: the corresponding element in the generic 4D-tensor is:
[└dlf0_off/ (┌E1/eps┐ * E3 * ┌E2/32┐ * 32 * eps)┘]
[(└dlf0_off/ (┌E2/32┐ * 32 * eps)┘ MOD E3]
[(└dlf0_off/ eps)┘ MOD (┌E2/32┐ * 32)]
[(└dlf0_off/ (E3 * ┌E2/32┐ * 32 * eps)┘ MOD ┌E1/eps┐) * eps
    + (dlf0_off MOD eps)]
```

Pad elements are ignored for the input tensors and model dependent for output tensors. It is model dependent if PER storage-alteration is detected on pad elements of output tensors.

For convolutional neural network based artificial intelligence models, the meaning of the 4 dimensions of a feature tensor can generally be mapped to:
E4: N—Size of mini-batch
E3: H—Height of the 3D-tensor/image
E2: W—Width of the 3D-tensor/image
E1: C—Channels or classes of the 3D-tensor

For machine learning or recurrent neural network based artificial intelligence models, the meaning of the 4 dimensions of a 4D-feature tensor (data-layout-format 0) may generally be mapped to:
E4: T—Number of time-steps or models
E3: Reserved, generally set to 1
E2: N_{mb}—Minibatch size
E1: L—Features

The NNPA data layout format 0 provides, e.g., two dimensional data locality with 4k-Bytes blocks of data (pages) as well as 4k-Byte block data alignment for the outer dimensions of the generated tensor.

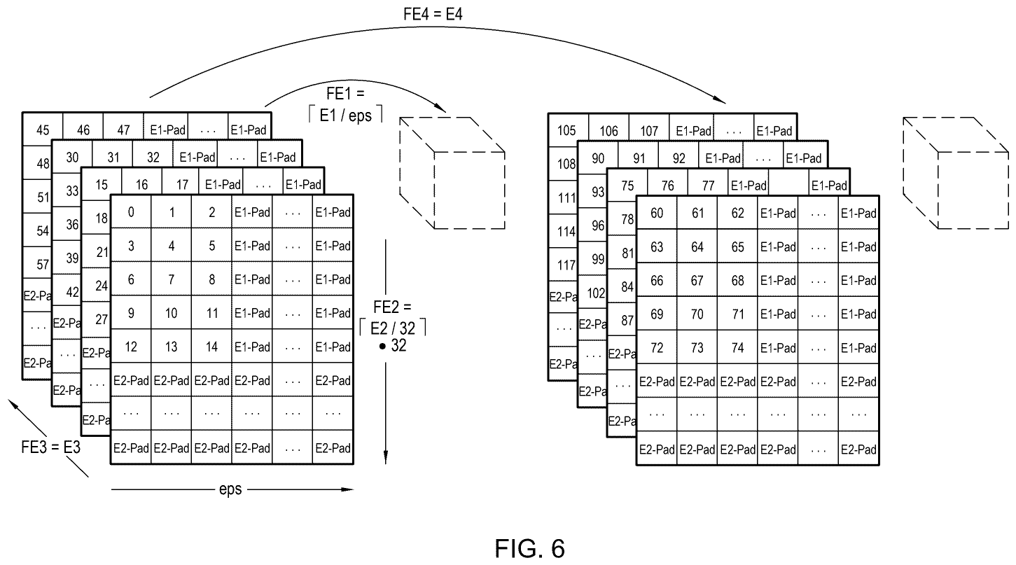

Data-Layout-Format-1: In addition to the 4D-feature tensor layout (data-layout-format 0), in one example, a neural network processor may support a 4D-kernel tensor, which re-arranges the elements of a 4D-tensor to reduce the number of memory accesses and data gathering steps when executing certain artificial intelligence (e.g., neural network processing assist) operations, such as a convolution. A process for the transformation of a row-major generic 4D-tensor with dimensions E4, E3, E2, E1 (an example of which is depicted by FIG. 4) into an NNPA data-layout-format 1 4D-kernel tensor (also referred to herein as NNPA data layout format 1 4D-kernel tensor) is depicted by FIG. 7. The process begins with setting (702) e2_limit=┌E2/32┐*32, e1_limit=┌E1/eps┐*eps, and e4x=0. It is determined at 704 whether e4x<E4, and if not (704, F), the process ends. Otherwise (704, T), the process sets (706) e3x=0 and determines (708) whether e3x<E3. If not (708, F), the process sets (710) e4x=e4x+1 and returns to 704. Otherwise (708, T), the process sets (712) e2x=0 and determines (714) whether e2x<e2_limit. If not (714, F), the process sets (716) e3x=e3x+1 and returns to 708. Otherwise (714, T), the process sets (718) e1x=0, then determines (720) whether e1x<e1_limit. If not (720, F), the process sets (722) e2x=e2x+1 and returns to 714. Otherwise (720, T), the process sets (724) kern_stick_pos=(└e1x/eps┘*E4*E3*e2_limit*eps)+(e2_limit*e3x*eps)+(e2x*eps)+(e4x*E3*e2_limit*eps)+(e1x MOD eps). The process continues by determining (726) whether e2x<E2. If not (726, F), the process sets (738) value=E2_pad. If instead at 726 it is determined that e2x is less than E2 (726, T), the process determines (728) whether e1x<E1. If not (728, F), the process sets (730) value=E1_pad. Otherwise, (728, T), the process sets (736) value=input_array [e4x][e3x][e2x][e1x]. After a value is set (either by 730, 736, or 738), the process continues by setting (732) OutputTensor [kern_stick_pos]=value, setting (734) e1x=e1x+1, then returning to 720.

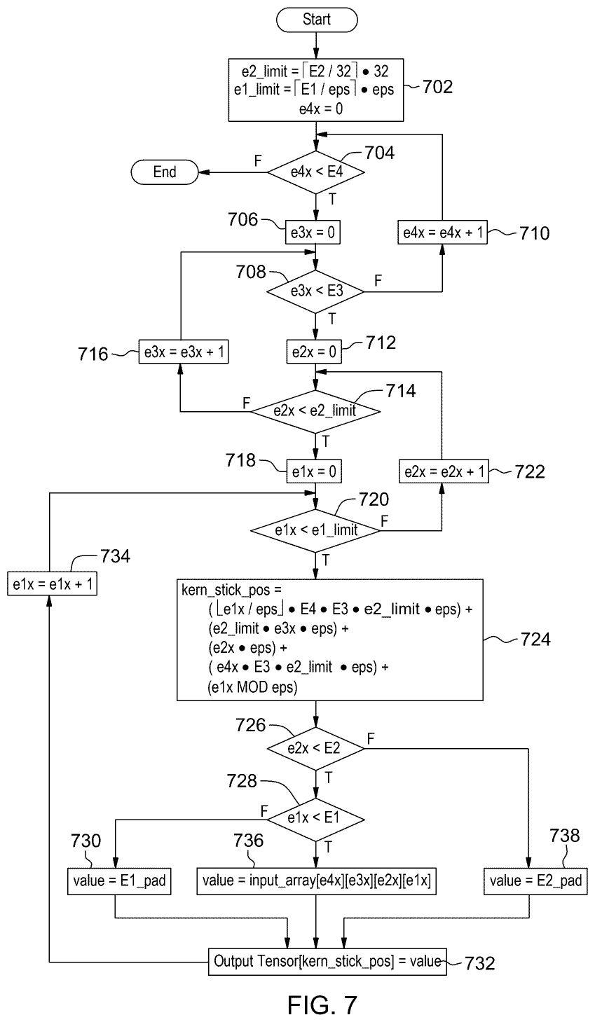

An example of a NNPA data-layout-format-1 4D-kernel tensor is depicted by FIG. 8. The kernel tensor of FIG. 8 has dimensions ┌E1/eps┐, E4, E3, ┌E2/32┐*32, eps. As an example, the element [0][1][0][2][1] is the value 67. Cells labeled E1-Pad are E1 padding, while cells labeled E2-Pad are E2 padding. eps refers to elements per stick, for example 64 for NNP-data-type 1, and 128 for INT8.

A resulting tensor can be represented as a 4D-tensor of, e.g., eps-element vectors or a 5D-tensor with dimensions FE1, FE4, FE3, FE2, FE0 respectively equal to:

┌E1/eps┐, E4, E3, ┌E2/32┐*32, eps, where ┌ ┐ refers to the ceil function. Another way of stating the preceding in examples is: E4*E3*ceil (E2/32)*32*ceil (E1/eps)*eps elements.)

The total size, in elements of the resulting tensor, is the product of these five dimensions.

An element [e4][e3][e2[e1] of the generic tensor may be mapped to the following element of the resulting 5D-tensor:

[└e1/eps┘][e4][e3][e2][e1 MOD eps], where └ ┘ refers to the floor function and mod is modulo. Another way of stating the preceding in examples is: element (└e1x/eps┘*E4*E3*e2_limit*eps)+(e4x*E3*e2_limit*eps)+(e3x*e2_limit*eps)+(e2x*eps)+(e1x mod eps), where e2_limit=┌E2/32┐*32 and e1_limit=┌E1/eps┐*eps.

The resulting tensor may have more elements than the generic tensor. Elements of the resulting tensor with no corresponding elements in the generic tensor are called pad elements.

Consider the element [fe1][fe4][fe3][fe2][fe0] of a NNPA data layout format 1 4D-feature tensor of eps element vectors or its equivalent representation as a 5D-tensor of elements. This element is either a pad element or its corresponding element in the generic 4D tensor with dimensions E4, E3, E2, E1 can be determined with the following formula:

```
  if fe2 ≥ E2 then this is an E2 (or page)-pad element
  else if fe1*eps+fe0 ≥ E1 then this is an E1 (or row)-pad element
  else the indices of the corresponding element in the generic 4D tensor are:
[fe4][fe3][fe2][fe1*eps+fe0].
```

Alternatively, consider the element at offset dlf1_off of an NNPA data layout format 1 4D-feature tensor. This element is either a pad element or its corresponding element in the generic 4D-tensor with dimensions E4, E3, E2, E1 and can be determined as follows:

```
  if dlf1_off MOD (┌E2/32┐ * 32 * eps) ≥ E2 * eps then this is an E2-pad
element
  else:
  - area4d = E4*E3*┌E2/32┐*32*┌E1/eps┐*eps
  - rem4d = dlf0_off MOD area4d
  - if (└rem3d/ (E4 * E3 * ┌E2/32┐ * 32 * eps)┘ == └E1/
eps┘ AND rem3d MOD eps ≥ E1 MOD eps) then this is an E1-pad element.
  else: the corresponding element in the generic 4D-tensor is:
[└ dlf1_off/ (E3 * ┌E2/32┐ * 32 * eps)┘ MOD E4]
[(└ dlf1_off/ (┌E2/32┐ * E2 * eps)┘) MOD E3]
[(└ (dlf1_off/ eps)┘) MOD (┌E2/32┐ * 32)]
[└ dlf1_off/ (E4 * E3 * ┌E2/32┐ * 32 * eps)┘ * eps + (dlf1_off MOD eps)].
```

Pad elements may be ignored for the input tensors and model dependent for output tensors. It is model dependent if PER storage-alteration is detected on pad elements of output tensors.

For convolutional neural network based artificial intelligence models, the meaning of the 4 dimensions of a kernel tensor (data-layout-format 1) can generally be mapped to:
E4: H—Height of the 3D-tensor/image
E3: W—Width of the 3D-tensor/image
E2: C—Number of Channels of the 3D-tensor
E1: K—Number of Kernels

The NNPA data layout format 1 provides, e.g., two dimensional kernel parallelism within 4k-Byte blocks of data (pages) as well as 4k-Byte block data alignment for the outer dimensions of the generate tensor for efficient processing.

Data-Layout-Format-2: In data-layout-format 2, the data type specifies an element size, e.g., of one byte, and the elements in even/odd rows are paired in storage. For example, elements in dimensions [E2,E1] appear in storage in the following order: [0,0], [1,0], [0,1], [1,1], [0,2], [1,2], and so forth.

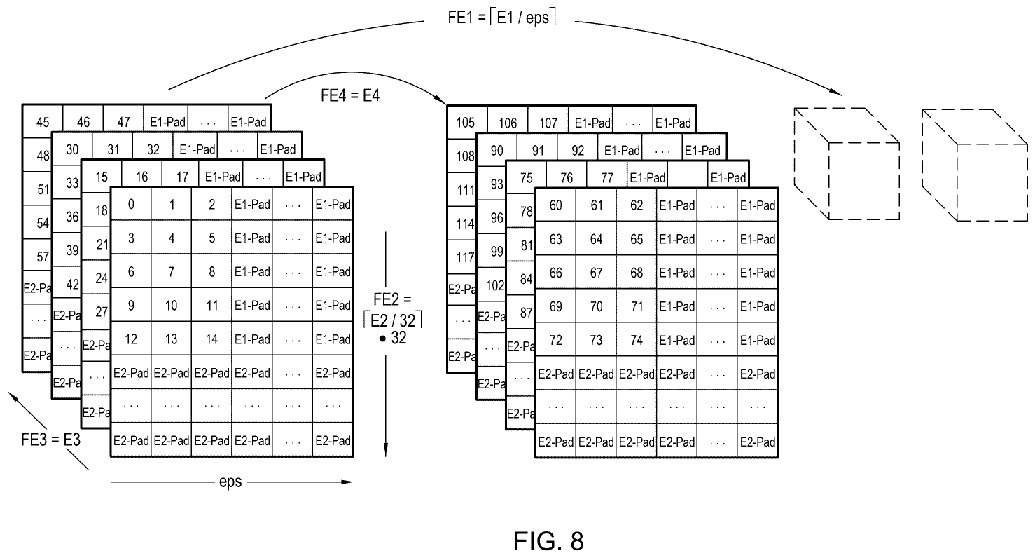

A process for the transformation of a row-major generic 4D-tensor with dimensions E4, E3, E2, E1 (an example of which is depicted by FIG. 4) into an NNPA data-layout-format 2 4D-weights tensor is depicted by FIG. 9. The process begins with setting (902) e2_limit=┌E2/64┐*64, e1_limit=┌E1/64┐*64, and e4x=0. It is determined at 904 whether e4x<E4, and if not (904, F), the process ends. Otherwise (904, T), the process sets (906) e3x=0 and determines (908) whether e3x<E3. If not (908, F), the process sets (910) e4x=e4x+1 and returns to 904. Otherwise (908, T), the process sets (912) e2x=0 and determines (914) whether e2x<e2_limit. If not (914, F), the process sets (916) e3x=e3x+1 and returns to 908. Otherwise (914, T), the process sets (918) e1x=0, then determines (920) whether e1x<e1_limit. If not (920, F), the process sets (922) e2x=e2x+1 and returns to 914. Otherwise (920, T), the process sets (924) arr_stick_pos=(e4x*E3*e2_limit*e1_limit)+(e3x*e2_limit*64)+(└e2x/2┘*128)+(└e1x/64┘*e2_limit*e3*64)+(e1x*2 MOD 128)+(e2x MOD 2). The process continues by determining (926) whether e2x<E2. If not (926, F), the process sets (938) value=E2_pad. If instead at 926 it is determined that e2x is less than E2 (926, T), the process determines (928) whether e1x<E1. If not (928, F), the process sets (930) value=E1_pad. Otherwise, (928, T), the process sets (936) value=input_array [e4x][e3x][e2x][e1x]. After a value is set (either by 930, 936, or 938), the process continues by setting (932) OutputTensor [arr_stick_pos]=value, then sets (934) e1x=e1x+1, before returning to 920.

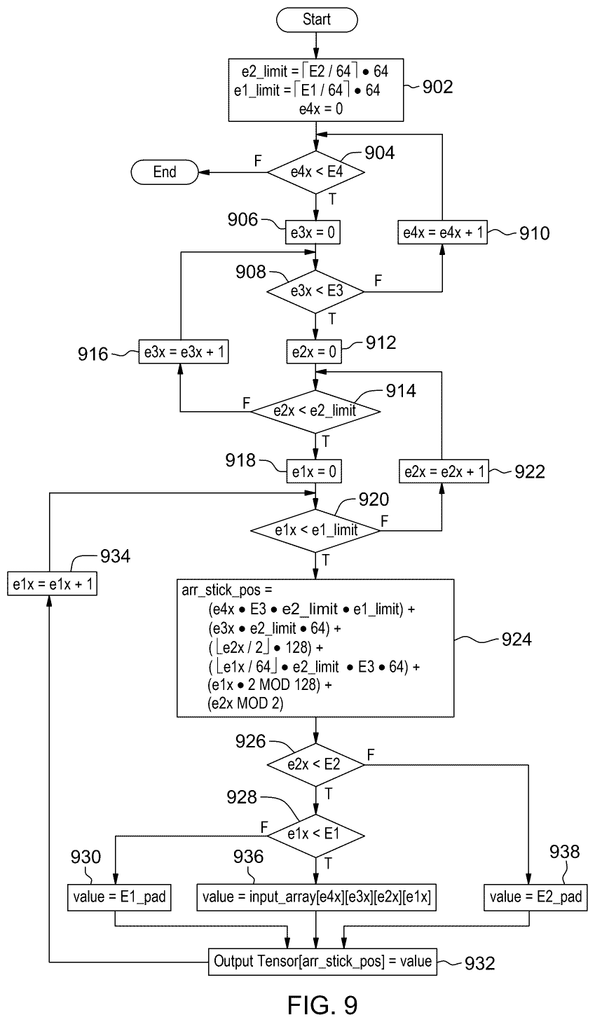

An example of an NNPA data-layout-format-2 4D-weights tensor is depicted by FIG. 10. The weights tensor of FIG. 10 has dimensions, in this example, of E4, [E1/64], E3, [E2/64]*32, 64, 2. As an example, the element [1][0][0][2][1][0] is the value 67. Cells labeled E1-Pad are E1 padding, while cells labeled E2-Pad are E2 padding.

The resulting tensor can be represented as a 4D-tensor of 64 element-pair vectors or a 6D-tensor with dimensions FE4, FE1, FE3, FE2, FE0, FEP respectively equal to E4, [E1/64], E3, [E2/64]*32, 64, 2.

An element [e4][e3][e2][e1] of the generic tensor will be mapped to the following element of the resulting 6D-tensor: [e4][└e1/64┘][e3][└e2/2┘][e1 MOD 64][e2 MOD 2].

The resulting tensor may have more elements than the generic tensor. All elements of the resulting tensor with no corresponding elements in the generic tensor are called pad elements.

Consider the element [fe4][fe1][fe3][fe2][fe0][fep] of a 6D representation of an NNPA data-layout-format-2 or -3 4D-weights tensor. This element is either a pad element or its corresponding element in the generic 4D tensor with dimensions E4, E3, E2, E1, and can be determined with the following formula:

```
  if: fe2 * 2 + fep ≥ └E2 + 1/2┘*2, then this is an E2-pad element.
  else if: fe2 * 2 + fep ≥ E2, or fe1*64+ fe0 ≥ E1, then this is a E1-pad element
  else: the indices of the corresponding element in the generic 4D-tensor are: [
fe4 ] [ fe3 ] [ fe2 * 2 + fep] [ fe1 * 64 + fe0].
```

Alternatively, consider the element at offset dlf2_off of an NNPA data-layout-format-2 or -3 4D-weights tensor. This element is either a pad element or its corresponding element in the generic 4D-tensor with dimensions E4, E3, E2, E1. To simplify the process of converting an offset of a 4D-weights tensor into the indices of a 4D-generic tensor, the prospective indices may first be determined as follows:

```
  e2_limit = ┌E2/64┐* 64
  e1_limit = ┌E1/64┐ * 64
  area_3d = E3 * e2_limit * e1_limit
  e4x = └dlf2_off/area_3d┘
  e3x = └dlf2_off/ (e2_limit * 64)┘ MOD E3
  e2x = └dlf2_off/128┘ MOD └e2_limit/2┘ * 2 + dlf2_off MOD 2
  e1x = └dlf2_off/ (E3 * e2_limit * 64)┘ MOD └e1_limit/64┘ * 64 +
└dlf2_off/2┘ MOD 64.
```

The determination of whether an offset is a pad element or an element in the 4D-generic tensor is as follows:

```
  if: e2x >= (E2 + 1) / 2 * 2, then this is an E2-pad element.
  if (e2x >= E2) OR (e1x >= E1), then this is an E1-pad element
  else the corresponding element in the generic 4D-tensor is [e4x] [e3x] [e2x]
[e1x].
```

Pad elements may be ignored for the input tensors and model dependent for output tensors. It is model dependent if PER storage-alteration is detected on pad elements of output tensors.

Data-Layout-Format-31: As noted elsewhere herein and as described previously, a data-layout-format-31 tensor is a row-format generic tensor, that is an unstickified tensor without padding. In embodiments, a transformation function can be used to transform tensors, for instance to transform a data-layout-format 31 tensor to and from a data-layout-format-0 4D-feature tensor.

Again, although example data layout formats are provided herein, other data layout formats may be supported by the processor (e.g., neural network processor).

As noted previously, a query function may be provided that conveys detailed information, for instance information relating to a specific model of a selected processor (e.g., neural network processor). The detailed information can include, for instance, model-dependent information relating to a specific processor. (A processor may also support standard data attributes, such as standard data types, standard data layouts, etc., which are implied and not necessarily presented by the query function, although, in another embodiment, the query function may indicate all or various selected subsets of data attributes, etc.) Although example information is provided, other information may be provided in other embodiments. The obtained information, which may be different for different models of a processor and/or of different processors, can be used to perform artificial intelligence and/or other processing. A specific non-query function employed in the processing is performed by executing the Neural Network Processing Assist instruction one or more times and specifying the non-query specific function.

Further details of an example non-query function supported by the Neural Network Processing Assist instruction are now described. Specifically, an example such function transforms tensors between formats, that is, it reformats tensors to transform from one format to another format. A transformation, or reformatting, in this context refers to a transformation of the data-layout format and/or data type of the elements of the tensor. In accordance with aspects described herein, the NNPA instruction is extended to support an NNPA-TRANSFORM function (with Function Code 240), as described herein. With respect to this transformation function for reformatting, the NNPA parameter block in storage can include elements discussed herein, such as PBVN, a descriptor of an input tensor (such as a descriptor as shown by the example of FIG. 3F), an output tensor descriptor (such as a descriptor as shown by the example of FIG. 3F), and one or more function specific parameters, for instance FSP 1 to specify a code for a transformation operation, and optionally other FSP(s) depending on the transformation operation, as examples. In a specific example, the parameter block in storage is that of the example shown by FIG. 3E.

As described elsewhere herein, data elements used in common artificial-intelligence (AI) models can appear in memory as a tightly-packed multiple-dimension array referred to herein as a generic tensor. Generic tensor elements are often in the IEEE 32-bit floating-point format, but may also appear in other formats, for instance as 8-bit signed binary integers. For performance reasons, an AI accelerator might require that one or more dimensions, such as dimensions 1 and 2, of a tensor be formatted such that the elements of these dimensions are aligned on integral boundaries in memory. In some examples, the accelerator might primarily operate on elements in a different format, for instance a 16-bit floating-point format referred to as NNP data-type-1. The feature tensor (4D-feature tensor) with the tensor format ‘Data-Layout-Format 0’ discussed herein is one type of tensor that has been transformed into this format.

Software transformation between the generic and accelerator-capable tensor formats can be expensive, yet such transformations may be required several times in the processing of a neural network represented by the tensor.

Thus, in accordance with aspects described herein, an accelerator can be adapted to perform transformations between tensor formats efficiently. For instance, an instruction, such as the NNPA instruction, is enhanced to provide a transform function to transform between tensor formats, for instance the generic and feature tensor formats. Thus, in examples, it transforms between element data types, e.g., between IEEE 32-bit floating point, NNP data-type-1, and 8-bit signed binary integer, as examples.

A function-specific parameter can indicate the type of transformation that is to be performed. An example such type of transformation is to transform from a generic tensor format to a feature-tensor format, for instance to transform IEEE 32-bit floating-point elements to NNP data-type-1 elements (16-bit floating point) or 8-bit signed binary integers. In some examples of this type of transformation, options for quantization with clipping are available, as described herein. Another example type of transformation is to transform from a feature tensor format to a generic tensor format, for instance to transform NNP data-type-1 elements to IEEE 32-bit floating-point elements. Other transformations are possible.

In the context of a NNPA-TRANSFORM function when specified, the content of an input tensor, such as input-tensor 1 specified by the NNPA parameter block, is transformed into a different data-layout format and data type, and the result of the transformation is stored in an output tensor, such as output-tensor 1 specified by the NNPA parameter block.

Bit(s), e.g., bits 24-31 of function-specific parameter 1 (FSP1), contain a transformation operation code (TOC), for instance an 8-bit unsigned binary integer TOC, specifying the type of transformation to be performed. In examples, bit 0 of FSP1 contains a saturation control (SC) that is used by some of the transformation operations. Bit(s), e.g., bits 1-23 of FSP1, are reserved and are to contain zeros.

Example transformation operation codes, the corresponding data-layout format and data type for input-tensor 1, and the resulting data-layout format and data types in output-tensor 1 are shown in Table 2:

TABLE 2

| | | |
|---|---|---|
| TOC | Input Tensor | Output Tensor |

| (Decimal) | (Hex) | DLF | DT | DLF | DT |
|---|---|---|---|---|---|
| 2 | 2 | 31 | 6 | 0 | 0 |
| 6 | 6 | 31 | 6 | 0 | 8 |
| 129 | 81 | 0 | 0 | 31 | 6 |

As discussed herein, DLF (data layout format) 0 refers to data-layout-format 0, a stickified format, and DLF 31 refers to data-layout-format 31, an unstickified format. DT 0 refers to 16-bit floating-point value (e.g., NNP data-type 1), DT 6 refers to IEEE 32-bit floating-point value, and DT 8 refers to 8-bit signed binary integer.

In examples, the NNPA-TRANSFORM function is available when the parameter-block version number (PBVN) is greater than zero. If the PBVN is zero, a response code, e.g., 0001 hex, is set in general register 0, and the instruction completes with a condition code, e.g., 1.

In examples, if an unsupported transformation operation code is specified in, e.g., function-specific parameter 1, then a response code, e.g., F000 hex, is set in general register 0 and the instruction completes with a condition code, e.g., 1.

If the data-layout formats specified in the input- and output-tensor descriptors are not supported for the specified transformation operation, then a response code, e.g., 0010 hex, is set in general register 0 and the instruction completes with a condition code, e.g., 1. If the data types specified in the input and output tensor descriptors are not supported for the specified transformation operation, then a response code, e.g., 0011 hex, is set in general register 0 and the instruction completes with a condition code, e.g., 1.

In examples, the shape of input-tensor 1 and the output-tensor 1 is to be the same, otherwise, a general-operand data exception may be recognized.

In examples, the input-tensor-descriptor 2, input-tensor-descriptor 3, output-tensor-descriptor 2, and function-specific-save-area-address fields may be ignored. Further, for one or more TOCs, such as 2 and 129, FSP(s), such as FSP2 and above, may be ignored. For other TOC(s), such as TOC 6, FSP(s), such as FSP 6 and above, may be ignored.

Further details of reformatting an input tensor having one format to provide an output tensor having another format are provided, and specifically with respect to the different TOCs noted above.

NNPA-TRANSFORM TOC 2 Processing: TOC 2 transforms BFP-short-format elements from the generic-format input-tensor 1 into NNP-data-type-1 elements in the data-layout-format-0 output-tensor 1.

When the transformation of an input-tensor-1 element results in a value that exceeds the smallest or largest value that can be represented in the NNP-data-type-1 format of output-tensor 1, the saturation control (SC) in, e.g., bit position 0 of FSP 1 can apply, as follows:

| SC | Result |
|---|---|
| 0 | The resulting element is a nonnumeric value. The range- |
| | violation status flag is set to, e.g., one |
| 1 | The resulting element contains the smallest or largest value, |
| | as appropriate, in the NNP-data-type-1 format. The range- |
| | violation status flag is not set |

Although this transformation (TOC 2) converts IEEE 32-bit floating-point into NNP-data-type 1, the saturation control could also be applicable to transformation(s) where the result might not fit into the output data format.

Regardless of the saturation control, any input-tensor 1 element that is nonnumeric or an infinity can result in an output-tensor 1 element that is nonnumeric, and the range-violation status flag may be set to one.

NNPA-TRANSFORM TOC 6 Processing: TOC 6 transforms BFP-short-format elements from the generic-format input-tensor 1 into 8-bit signed-binary-integer elements in the data-layout-format 0 output-tensor 1 and provides a means of applying scale, offset, and clip values when forming the resulting elements.

An input-tensor-1 element is transformed from the BFP-short format into an intermediate value in the NNP-data-type-1 format that is then processed with a scale, offset, and clipping values (described below). When the transformation to an intermediate value results in a value that exceeds the smallest or largest value that can be represented in the NNP-data-type-1 format needed for scaling, the saturation control (SC) in, e.g., bit position 0 of FSP 1 can apply, as follows:

| SC | Result |
|---|---|
| 0 | The resulting intermediate value is a nonnumeric value. |
| | The range-violation status flag is set to, e.g., one. |
| 1 | The resulting intermediate value contains the smallest or |
| | largest value, as appropriate, in the NNP-data-type-1 |
| | format, and the range-violation status flag is not set based |
| | on intermediate computations |

Regardless of the saturation control, the range-violation flag may be set to, e.g., one in general register 0, if any input-tensor-1 element is nonnumeric or infinity; such values result in an intermediate value that is nonnumeric.

Bit positions, e.g., bit positions 16-31, of FSPs, e.g., FSPs 2 and 3, can contain the scale and offset values in, e.g., the NNP-data-type-1 format, and bit positions, e.g., 24-31 of FSPs, e.g., FSPs 4 and 5, can contain the clip_min (minimum-clip) and clip_max (maximum-clip) values in, e.g., the 8-bit signed binary integer format. Other bit positions, e.g., 0-15 of FSPs 2 and 3 and bit positions 0-23 of FSPs 4 and 5, may be reserved and are to contain zeros.

Each intermediate value may be processed according to the following formula, with the result being placed into the corresponding element of output-tensor 1: output_element=MIN (clip_max, MAX (intermediate_value*scale+offset, clip_min)), with the following Explanations:
clip_max-Maximum clip value in FSP 5 (INT8 format).
clip_min-Minimum clip value in FSP 4 (INT8 format).
INT8-8-bit signed binary integer. [already defined way above but still put here]
Offset-Offset value in FSP 3 (NNP data-type-1 format).
Scale-Scaling factor from FSP 2 (NNP data-type-1 format).

If a range violation is recognized when computing an output element, then the resulting element value is unpredictable.

When TOC 6 is specified, the minimum-clip value, e.g., in FSP 4, is to be less than the maximum-clip value, e.g., in FSP 5, otherwise, a general-operand data exception may be recognized.

When the scale value, e.g., in FSP2, is zero or a nonnumeric value of either sign, or when the offset value, e.g., in FSP3 is a nonnumeric value of either sign, then a response code, e.g., F001 hex, may be set in general register 0, and the instruction completes with a condition code, e.g., 1.

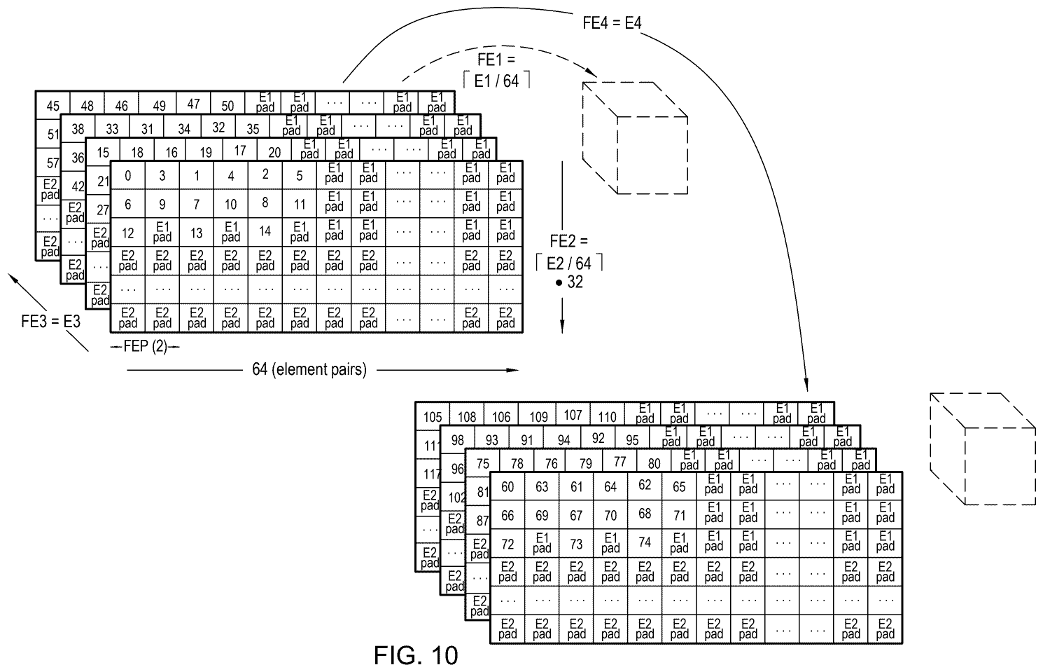

By the above, element quantization may be provided. FIG. 11 depicts example element quantization processing, in accordance with aspects described herein. Referring to FIG. 11, the process takes an input element as input and returns a Returned_Element (with the input element being the ‘intermediate element’ mentioned above and the Returned_Element being the ‘output element’ mentioned above). The process sets (1102) Returned_Element=(Input_Element*a_scale)+a_offset. The process then determines (1104) whether Returned_Element<clip_min. If so (1104, T), the process sets (1106) Returned_Element=clip_min and proceeds to 1112 to return Returned_Element. If instead it is determined at 1104 that Returned_Element is not less than clip_min (1104, F), the process determines (1108) whether Returned_Element>clip_max. If so (1108, T), the process sets (1110) Returned_Element=clip_max and proceeds to 1112 to return Returned_Element. If instead it is determined at 1108 that Returned_Element is not greater than clip_max (1108, F), the process proceeds to 1112 to return Returned_Element.

NNPA-TRANSFORM TOC 129 Operation: TOC 129 transforms NNP-data-type-1 elements from the data-layout-format-0 input-tensor 1 into BFP-short-format elements in the generic-format output-tensor 1.

In embodiments, when the transformation-operation code (TOC) is 129, the following applies:
The saturation control does not apply. Bit position, e.g., 0 of, e.g., FSP 1, is reserved and is to contain zero.
An 8 K-byte function-specific-save area (FSSA) may be used by this function to save intermediate results.
The FSSA address in the parameter block is to designate a 4 K-byte boundary, otherwise, a response code, e.g., 0015 hex, is set in general register 0, and the instruction completes with a condition code, e.g., 1.

In examples, when the TOC is not 129, a function-specific-save area is not accessed, and so no boundary exception condition is recognized.

As described, element quantization can reformat input elements to provide output elements. The element quantization performed on an input element can include converting the input element to an output element (e.g., of the second data type) as an element of the output tensor. The converting uses the scale value to scale to the input element, uses the offset value to apply an offset, and uses the clip maximum and clip minimum values to enforce a maximum value and a minimum value for the output element. In some examples, the conversion determines an intermediate value based on the input element, the scale value, and the offset value, then converts the intermediate value to an element of the second data type, and then performs clip processing using that element of the second data type, the clip maximum value, and the clip minimum value, to determine an output element of the second data type. In other examples, the clip processing could be performed before the conversion of the intermediate value to the element of the second data type. For instance, the clipping could be performed after the input element it scaled and the offset is applied, which effectively provides an intermediate value that is then converted to the element of the second data type. In this regard, the clipping can be performed before or after the conversion provides the element of the second data type.

Thus, with TOC 2 operation, the processing obtains input tensor 1 having the generic format (unstickified) and containing IEEE 32-bit floating-point data type elements, and reformats the input tensor to provide an output tensor having data-layout-format-0 format (stickified) and containing 16-bit floating-point (NNP-data-type 1) data type elements. With TOC 6 operation, the processing obtains input tensor 1 having generic format (unstickified) and containing IEEE 32-bit floating-point data type elements, and reformats the input tensor to provide an output tensor having data-layout-format-0 format (stickified) and containing 8-bit unsigned binary integer data type elements, applying element quantization in some embodiments. With TOC 129 operation, the processing obtains input tensor 1 having data-layout-format 0 format (stickified) and containing 16-bit floating-point data type elements, and reformats the input tensor to provide an output tensor in the generic format (unstickified) and containing IEEE 32-bit floating-point data type elements.

Accordingly, embodiments of aspects described herein present a computer system that can include a neural network accelerator. The computer system can include/perform a method for decoding and executing a computer instruction that operates on tensors. The tensors can include an input tensor in a first data-layout format and having elements in a first data type, and an output tensor in a second data-layout format (differing from that of the input tensor) and having elements in a second data type (differing from that of the input tensor). A function of the computer instruction can provide transformation/reformatting/converting of input tensor to the output tensor, for instance converting the data-layout format and data type of the input-tensor's elements into the data-layout format and element data-type of the output tensor. Depending on the data-type conversions, optionally provided is an operation that performs quantization of the elements being converted, by factoring with a scale, adding an offset, and clipping (if necessary) the resulting values to a specified range.

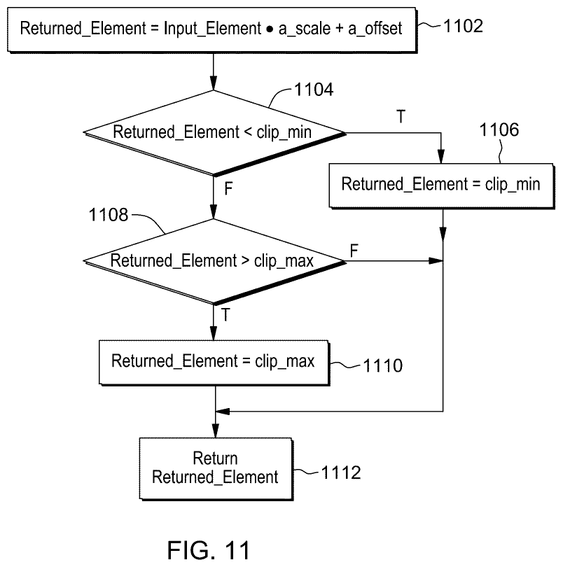

FIG. 12A depicts one example of tensor transformation code of FIG. 1, in accordance with aspects described herein. In one or more aspects, tensor transformation code 150 includes, in one example, various sub-modules to be used to perform tensor transformation. The sub-modules are, e.g., computer-readable program code (e.g., instructions) in computer-readable media, e.g., storage (persistent storage 113, cache 121, storage 124, other storage, as examples). The computer-readable storage media may be part of one or more computer program products and the computer-readable program code may be executed by and/or using one or more computing devices (e.g., one or more computers, such as computer(s) 101, computers of cloud 105/106, and/or other computers; one or more servers, such as remote server(s) 104 and/or other remote servers; one or more devices, such as end user device(s) 103 and/or other end user devices; one or more processors or nodes, such as processor(s) or node(s) of processor set 110 and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute one or more of the sub-modules and/or portions thereof. Many examples are possible.

Referring to FIG. 12A, tensor transformation code 150 includes obtain instruction code 1202 to obtain (e.g., receive, be provided, pull, retrieve, fetch, etc.) an instruction, such as an instruction to perform tensor transformation in accordance with aspects described herein, and execute instruction code 1204 to execute the instruction.

Further details of execute instruction code 1204 are described with reference to FIG. 12B. Referring to FIG. 12B, execute instruction code 1204 includes obtain input tensor code 1210 for obtaining an input tensor having a first data-layout format and elements of a first data type. Execute instruction code 1204 also includes an optional obtain transformation indicator code 1212 for obtaining a transformation indicator, for instance obtaining the transformation indicator from a parameter block specified by the instruction, where the transformation indicator indicates a second data-layout format and a second data type to use in reformatting the input tensor. Execute instruction code 1204 further includes reformat tensor code 1214 for reformatting the input tensor to provide an output tensor having the second data-layout format (where the second data-layout is different from the first data-layout format) and elements of the second data type (where the second data type is different from the first data type).

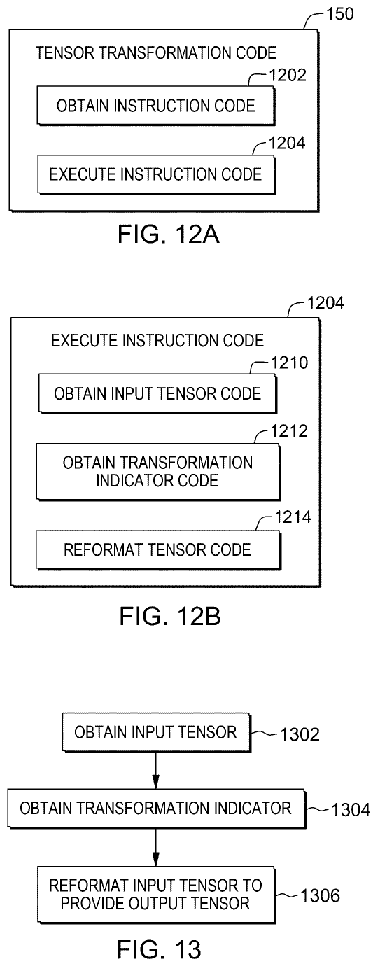

FIG. 13 depicts an example process for tensor transformation, in accordance with aspects described herein. The process may be executed, in one or more examples, by a processor or processing circuitry of one or more computers/computer systems, such as those described herein, and more specifically those described with reference to FIG. 1. In one example, code or instructions implementing the process(es) of FIG. 13 are part of a code module, such as code 150. In other examples, the code may be included in one or more modules and/or in one or more sub-modules of the one or more modules. Various options are available.

The process of FIG. 13 includes obtaining (1302) an input tensor having a first data-layout format and elements of a first data type. The process also, and optionally, includes obtaining (1304) a transformation indicator that indicates a second data-layout format and a second data type to use in reformatting the input tensor. Reformatting can be performed based on the transformation indicator. In examples, this transformation indicator is obtained from a parameter block specified by the instruction. In any case, the process further includes reformatting (1306) the input tensor to provide an output tensor having the second data-layout format, the second data-layout being different from the first data-layout format, and elements of the second data type, the second data type being different from the first data type.

In some embodiments, the first data-layout format includes a tensor format in which elements are provided in increasing memory address order, and the first data type is floating-point type.

In some embodiments, the second data-layout format includes a fixed-size tensor format in which a dimension of the tensor is a fixed-size and a number of elements arrayed in the dimension is based on the fixed-size and element size.

In some embodiments, the first data type is floating-point type of a first bit length and the second data type is floating-point type of a second bit length that is different from the first bit length.

In some embodiments, the second data type is integer type.

In some embodiments, the first data-layout format includes a fixed-size tensor format in which a dimension of the tensor is a fixed-size and a number of elements arrayed in the dimension is based on the fixed-size and element size, and the first data type is floating-point type.

In some embodiments, the second data-layout format includes a tensor format in which elements are provided in increasing memory address order, the first data type is floating-point type of a first bit length, and the second data type is floating-point type of a second bit length that is different from the first bit length.

In some embodiments, as part of the reformatting (e.g., 1306) optional additional operations, for instance element quantization, is/are performed. Thus, in accordance with some embodiments, executing the instruction further includes obtaining from a parameter block specified by the instruction a scale value, an offset value, a clip maximum value, and a clip minimum value for enforcing output values within a specified range. The reformatting can include performing element quantization on input elements of the input tensor, where the element quantization performed on an input element of the input tensor includes converting the input element to an output element, of the second data type, as an element of the output tensor, where the converting uses the scale value to scale to the input element, uses the offset value to apply an offset, and uses the clip maximum and clip minimum values to enforce a maximum value and a minimum value for the output element.

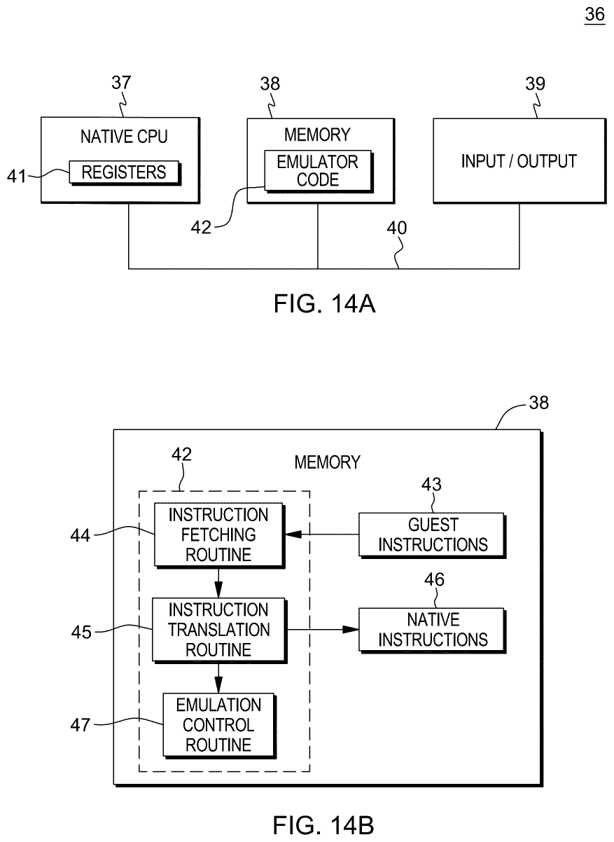

Although one or more examples of a computing environment to incorporate and use one or more aspects of the present disclosure are described herein, FIGS. 14A-14B depict another embodiment of a computing environment to incorporate and use one or more aspects of the present disclosure.

Referring, initially, to FIG. 14A, in this example, a computing environment 36 includes, for instance, a native central processing unit (CPU) 37 based on one architecture having one instruction set architecture, a memory 38, and one or more input/output devices and/or interfaces 39 coupled to one another via, for example, one or more buses 40 and/or other connections.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture (different from the one architecture) and to execute software and instructions developed based on the other architecture.

Further details relating to emulator code 42 are described with reference to FIG. 14B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the other instruction set architecture, but instead, are being emulated on native central processing unit 37, which may be, for example, the one instruction set architecture. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native central processing unit 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native central processing unit or by using locations in memory 38. In embodiments, guest instructions 43, native instructions 46 and emulator code 42 may reside in the same memory or may be disbursed among different memory devices.

The computing environments described herein are only examples of computing environments that can be used. One or more aspects of the present disclosure may be used with many types of environments. The computing environments provided herein are only examples. Each computing environment is capable of being configured to include one or more aspects of the present disclosure. One or more aspects of the present disclosure are tied to computer technology and facilitate processing within a computer, improving performance thereof. For instance, processing speed is increased, and latency is reduced by using one instruction, e.g., one architected instruction, to perform tensor transformation as described herein.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product comprising:
a set of one or more computer-readable storage media;
program instructions, collectively stored in the set of one or more computer-readable storage media, for causing at least one computing device to perform computer operations including:
executing an instruction, the executing the instruction including:
obtaining an input tensor having a first data-layout format and elements of a first data type; and
reformatting the input tensor to provide an output tensor having a second data-layout format, the second data-layout being different from the first data-layout format, and elements of a second data type, the second data type being different from the first data type.

2. The computer program product of claim 1, wherein the executing further includes obtaining from a parameter block specified by the instruction a transformation indicator, the transformation indicator indicating the second data-layout format and the second data type to use in the reformatting the input tensor, wherein the reformatting is performed based on the transformation indicator.

3. The computer program product of claim 1, wherein the first data-layout format includes a tensor format in which elements are provided in increasing memory address order, and the first data type is floating-point type.

4. The computer program product of claim 3, wherein the second data-layout format includes a fixed-size tensor format in which a dimension of the tensor is a fixed-size and a number of elements arrayed in the dimension is based on the fixed-size and element size.

5. The computer program product of claim 4, wherein the first data type is floating-point type of a first bit length and the second data type is floating-point type of a second bit length that is different from the first bit length.

6. The computer program product of claim 4, wherein the second data type is integer type.

7. The computer program product of claim 1, wherein the first data-layout format includes a fixed-size tensor format in which a dimension of the tensor is a fixed-size and a number of elements arrayed in the dimension is based on the fixed-size and element size, and the first data type is floating-point type.

8. The computer program product of claim 7, wherein the second data-layout format includes a tensor format in which elements are provided in increasing memory address order, and wherein the first data type is floating-point type of a first bit length and the second data type is floating-point type of a second bit length that is different from the first bit length.

9. The computer program product of claim 1, wherein the executing further includes obtaining from a parameter block specified by the instruction a scale value, an offset value, and a clip maximum value and a clip minimum value for enforcing output values within a specified range, wherein the reformatting includes performing element quantization on input elements of the input tensor, and wherein the element quantization performed on an input element of the input tensor includes converting the input element to an output element, of the second data type, as an element of the output tensor, wherein the converting uses the scale value to scale to the input element, uses the offset value to apply an offset, and uses the clip maximum and clip minimum values to enforce a maximum value and a minimum value for the output element.

10. A computer system comprising:
at least one computing device;
a set of one or more computer-readable storage media; and
program instructions, collectively stored in the set of one or more computer-readable storage media, for causing the at least one computing device to perform computer operations including:
executing an instruction, the executing the instruction including:
obtaining an input tensor having a first data-layout format and elements of a first data type; and
reformatting the input tensor to provide an output tensor having a second data-layout format, the second data-layout being different from the first data-layout format, and elements of a second data type, the second data type being different from the first data type.

11. The computer system of claim 10, wherein the executing further includes obtaining from a parameter block specified by the instruction a transformation indicator, the transformation indicator indicating the second data-layout format and the second data type to use in the reformatting the input tensor, wherein the reformatting is performed based on the transformation indicator.

12. The computer system of claim 10, wherein the first data-layout format includes a tensor format in which elements are provided in increasing memory address order, and the first data type is floating-point type.

13. The computer system of claim 12, wherein the second data-layout format includes a fixed-size tensor format in which a dimension of the tensor is a fixed-size and a number of elements arrayed in the dimension is based on the fixed-size and element size.

14. The computer system of claim 13, wherein the first data type is floating-point type of a first bit length and the second data type is a floating-point type of a second bit length that is different from the first bit length, or the second data type is integer type.

15. The computer system of claim 10, wherein the first data-layout format includes a fixed-size tensor format in which a dimension of the tensor is a fixed-size and a number of elements arrayed in the dimension is based on the fixed-size and element size, and the first data type is floating-point type.

16. The computer system of claim 15, wherein the second data-layout format includes a tensor format in which elements are provided in increasing memory address order, and wherein the first data type is floating-point type of a first bit length and the second data type is floating-point type of a second bit length that is different from the first bit length.

17. The computer system of claim 10, wherein the executing further includes obtaining from a parameter block specified by the instruction a scale value, an offset value, and a clip maximum value and a clip minimum value for enforcing output values within a specified range, wherein the reformatting includes performing element quantization on input elements of the input tensor, and wherein the element quantization performed on an input element of the input tensor includes converting the input element to an output element, of the second data type, as an element of the output tensor, wherein the converting uses the scale value to scale to the input element, uses the offset value to apply an offset, and uses the clip maximum and clip minimum values to enforce a maximum value and a minimum value for the output element.

18. A computer-implemented method comprising:
executing an instruction, the executing the instruction including:
obtaining an input tensor having a first data-layout format and elements of a first data type; and
reformatting the input tensor to provide an output tensor having a second data-layout format, the second data-layout being different from the first data-layout format, and elements of a second data type, the second data type being different from the first data type.

19. The method of claim 18, wherein the executing further includes obtaining from a parameter block specified by the instruction a transformation indicator, the transformation indicator indicating the second data-layout format and the second data type to use in the reformatting the input tensor, wherein the reformatting is performed based on the transformation indicator.

20. The method of claim 18, wherein the first data-layout format includes a tensor format in which elements are provided in increasing memory address order, and the first data type is floating-point type.

21. The method of claim 20, wherein the second data-layout format includes a fixed-size tensor format in which a dimension of the tensor is a fixed-size and a number of elements arrayed in the dimension is based on the fixed-size and element size, and wherein the first data type is floating-point type of a first bit length and the second data type is floating-point type of a second bit length that is different from the first bit length, or the second data type is integer type.

22. The method of claim 18, wherein the first data-layout format includes a fixed-size tensor format in which a dimension of the tensor is a fixed-size and a number of elements arrayed in the dimension is based on the fixed-size and element size, and the first data type is floating-point type, wherein the second data-layout format includes a tensor format in which elements are provided in increasing memory address order, and wherein the first data type is floating-point type of a first bit length and the second data type is floating-point type of a second bit length that is different from the first bit length.

23. The method of claim 18, wherein the executing further includes obtaining from a parameter block specified by the instruction a scale value, an offset value, and a clip maximum value and a clip minimum value for enforcing output values within a specified range, wherein the reformatting includes performing element quantization on input elements of the input tensor, and wherein the element quantization performed on an input element of the input tensor includes converting the input element to an output element, of the second data type, as an element of the output tensor, wherein the converting uses the scale value to scale to the input element, uses the offset value to apply an offset, and uses the clip maximum and clip minimum values to enforce a maximum value and a minimum value for the output element.

24. A computer system comprising:
at least one hardware accelerator to be used in executing an instruction, the executing the instruction including:
obtaining an input tensor having a first data-layout format and elements of a first data type;
obtaining from a parameter block specified by the instruction:
a transformation indicator, the transformation indicator indicating a second data-layout format and a second data type to use in reformatting the input tensor;
a scale value;
an offset value; and
a clip maximum value and a clip minimum value for enforcing output values within a specified range; and
reformatting the input tensor to provide an output tensor having the second data-layout format, the second data-layout being different from the first data-layout format, and elements of a second data type, the second data type being different from the first data type, wherein the reformatting is performed based on the transformation indicator, wherein the reformatting includes performing element quantization on input elements of the input tensor, and wherein the element quantization performed on an input element of the input tensor includes converting the input element to an output element, of the second data type, as an element of the output tensor, wherein the converting uses the scale value to scale to the input element, uses the offset value to apply an offset, and uses the clip maximum and clip minimum values to enforce a maximum value and a minimum value for the output element.

25. A computer-implemented method comprising:
executing an instruction, the executing the instruction including:
obtaining an input tensor having a first data-layout format and elements of a first data type;
obtaining from a parameter block specified by the instruction:
a transformation indicator, the transformation indicator indicating a second data-layout format and a second data type to use in reformatting the input tensor;
a scale value;
an offset value; and
a clip maximum value and a clip minimum value for enforcing output values within a specified range; and
reformatting the input tensor to provide an output tensor having the second data-layout format, the second data-layout being different from the first data-layout format, and elements of a second data type, the second data type being different from the first data type, wherein the reformatting is performed based on the transformation indicator, wherein the reformatting includes performing element quantization on input elements of the input tensor, and wherein the element quantization performed on an input element of the input tensor includes converting the input element to an output element, of the second data type, as an element of the output tensor, wherein the converting uses the scale value to scale to the input element, uses the offset value to apply an offset, and uses the clip maximum and clip minimum values to enforce a maximum value and a minimum value for the output element.
